(19) United States
(12) Patent Application Publication
(10) Pub. No.: US 2019/0294990 A1
(43) Pub. Date: Sep. 26, 2019

(54) DETECTING FALSE POSITIVES IN STATISTICAL MODELS

(71) Applicant: Marcos LOPEZ DE PRADO, Harrison, NY (US)

(72) Inventor: Marcos LOPEZ DE PRADO, Harrison, NY (US)

(21) Appl. No.: 16/358,937

(22) Filed: Mar. 20, 2019

Related U.S. Application Data
(60) Provisional application No. 62/646,421, filed on Mar. 22, 2018.
(60) Provisional application No. 62/649,633, filed on Mar. 29, 2018.
(60) Provisional application No. 62/677,000, filed on May 27, 2018.

(51) Int. Cl. G06N 7/00; G06F 17/18; G06F 17/15; G06N 20/00

(52) U.S. Cl. CPC G06N 7/005; G06N 20/00; G06F 17/153; G06F 17/18

(57) ABSTRACT

A method of estimating whether a statistical model is a false positive, comprising receiving a plurality of predicted outcomes computed by a plurality of statistical models for a historical dataset, computing a correlation matrix for the plurality of predicted outcomes, clustering the plurality of predicted outcomes in a plurality of clusters according to a plurality of clustering schemes based on the correlation matrix, selecting a clustering scheme having a highest quality score among a plurality of clustering schemes, computing, for each of the clusters of the selected clustering scheme, an aggregated predicted outcome aggregating the predicted outcomes clustered in the respective cluster, computing an estimated variance across the clusters, and computing a false positive probability of a selected one of the plurality of statistical models based on the aggregated predicted outcome of the cluster comprising the selected statistical model, the number of clusters, and the estimated variance across all clusters.

### RELATED APPLICATIONS

This application claims the benefit of priority under 35 USC § 119(e) of U.S. Provisional Patent Application Nos. 62/646,421 filed on Mar. 22, 2018, 62/649,633 filed on Mar. 29, 2018, and 62/677,000 filed on May 27, 2018. The contents of the above applications are all incorporated by reference as if fully set forth herein in their entirety.

This application is also related to U.S. patent application Ser. No. 15/904,523 filed on Feb. 26, 2018 and U.S. patent application Ser. No. 14/672,028 filed on Mar. 27, 2015. The contents of the above applications are all incorporated by reference as if fully set forth herein in their entirety.

### RELATED DOCUMENTS

This application relates to publication “The Deflated Sharpe Ratio: Correcting for Selection Bias, Backtest Overfitting and Non-Normality” by David H. Bailey and Marcos Lopez de Prado, published Jul. 1, 2014, the contents of which are incorporated herein by reference in their entirety.

This application relates to publication “Finance as an Industrial Science” by Marcos Lopez de Prado, published Aug. 5, 2017, the contents of which are incorporated herein by reference in their entirety.

This application relates to publication “Advances in Financial Machine Learning” by Marcos Lopez de Prado, published Jan. 23, 2018, the contents of which are incorporated herein by reference in their entirety.

This application relates to publication “Detection of False Investment Strategies Using Unsupervised Learning Methods” by Marcos Lopez de Prado and Michael Lewis, published Apr. 23, 2018, the contents of which are incorporated herein by reference in their entirety.

This application relates to publication “A Data Science Solution to the Multiple-Testing Crisis in Financial Research” by Marcos Lopez de Prado, published May 11, 2018, the contents of which are incorporated herein by reference in their entirety.

### FIELD AND BACKGROUND OF THE INVENTION

The present invention, in some embodiments thereof, relates to detecting a false positive statistical model and, more specifically, but not exclusively, to detecting a false positive statistical model selected from a plurality of statistical models trained and tested on historical data.

Recent years have witnessed major advances made in the field of statistical models, specifically Machine Learning (ML) models and algorithms such as for example, neural networks, Support Vector Machines (SVM) and/or the like. As such models become more accessible they are being applied in a vast and diverse range of research and practical applications spanning almost any aspect of modern life ranging from physical phenomena research, through pattern and object detection to statistical analysis and prediction.

The statistical models may be trained to learn input to output mapping functions in one or more of a plurality of learning methodologies, for example, supervised learning, semi-supervised, unsupervised learning and/or any combination thereof. During the training stage the statistical model is trained using training data (sample data) such that the statistical model is fitted on the training data to learn how to map (i.e. classify and/or cluster) the training dataset to a plurality of labels, classes and/or clusters based on patterns identified in the training data and/or inferences derived from the training data.

The trained statistical models may be then applied on new (unseen) data samples to estimate a probable mapping of these data samples to the classes, clusters and/or labels identified during training.

However, training the statistical models with a limited data set may lead to overfitting of the statistical models. There are two major types of overfitting, overfitting of the training set and overfitting of the testing set. Training overfitting may occur when a statistical model is trained to explain random variations in the dataset, as opposed to a regular pattern present in the dataset (population). Testing overfitting may occur when a statistical model is selected from a multiplicity of candidates because it appears to perform well on the testing set.

### SUMMARY OF THE INVENTION

According to a first aspect of the present invention there is provided a method of estimating whether a statistical model selected from a plurality of statistical models trained using observed historical data is a false positive, comprising using one or more processors for:
Receiving a plurality of predicted outcomes computed by a plurality of statistical models for a historical dataset comprising a plurality of past observations.
Computing a correlation matrix for the plurality of predicted outcomes.
Clustering the plurality of predicted outcomes in a plurality of clusters according to a plurality of clustering schemes based on the correlation matrix. Each of the plurality of clustering schemes defines a different number of clusters.
Selecting a clustering scheme which achieves a highest quality score among a plurality of quality scores computed for the plurality of clustering schemes.
Computing, for each of the clusters of the selected clustering scheme, an aggregated predicted outcome which aggregates the predicted outcomes clustered in the respective cluster.
Computing an estimated variance across the clusters of the selected clustering scheme.
Computing a false positive probability of a selected one of the plurality of statistical models based on the aggregated predicted outcome of the cluster comprising the predicted outcome computed by the selected statistical model, the number of clusters in the selected clustering scheme, and the estimated variance across all clusters in the selected clustering scheme.

According to a second aspect of the present invention there is provided a system for estimating whether a statistical model selected from a plurality of statistical models trained using observed historical data is a false positive, comprising one or more processors executing a code. The code comprising:
Code instructions to receive a plurality of predicted outcomes computed by a plurality of statistical models for a historical dataset comprising a plurality of past observations.
Code instructions to compute a correlation matrix for the plurality of predicted outcomes.
Code instructions to cluster the plurality of predicted outcomes in a plurality of clusters according to a plurality of clustering schemes based on the correlation matrix. Each of the plurality of clustering schemes defines a different number of clusters.
Code instructions to select a clustering scheme which achieves a highest quality score among a plurality of quality scores computed for the plurality of clustering schemes.
Code instructions to compute, for each of the clusters of the selected clustering scheme, an aggregated predicted outcome which aggregates the predicted outcomes clustered in the respective cluster.
Code instructions to compute an estimated variance across the clusters of the selected clustering scheme.
Code instructions to compute a false positive probability of a selected one of the plurality of statistical models based on the aggregated predicted outcome of the cluster comprising the predicted outcome computed by the selected statistical model, the number of clusters in the selected clustering scheme, and the estimated variance across all clusters in the selected clustering scheme.

According to a third aspect of the present invention there is provided a method of estimating whether a selected statistical model trained using observed historical data is a false positive, comprising using one or more processors for:
Receiving a historical dataset comprising a plurality of past observations ordered along a past time flow.
Partitioning the plurality of observations to a plurality of groups each comprising a respective subset of the plurality of past observations.
Creating a plurality of combinatorial train-test sets each comprising the plurality of groups in a unique training-testing split in which at least some of the plurality of groups are included in a respective testing set and a reminder of the plurality of groups are included in a respective training set. The observations in the groups of each testing set are at least partially purged with respect to the observations in the groups of the respective training set.
Receiving a plurality of predicted outcomes, each computed by applying an evaluated statistical model trained with the training set of a respective one the plurality of combinatorial train-test sets to the testing set of the respective combinatorial train-test set.
Creating a plurality of virtual past time flows by aggregating the plurality of predicted outcomes.
Estimating whether the evaluated statistical model applied with one or more rules is a false based on a distribution of performance scores computed on the plurality of virtual past time flows.

According to a fourth aspect of the present invention there is provided a system estimating whether a selected statistical model trained using observed historical data is a false positive, comprising one or more processors executing a code. The code comprising:
Code instructions to receive historical dataset comprising a plurality of past observations ordered along a past time flow.
Code instructions to partition the plurality of observations to a plurality of groups each comprising a respective subset of the plurality of past observations.
Code instructions to create a plurality of combinatorial train-test sets each comprising the plurality of groups in a unique training-testing split in which at least some of the plurality of groups are included in a respective testing set and a reminder of the plurality of groups are included in a respective training set. The observations in the groups of each testing set are at least partially purged with respect to the observations in the groups of the respective training set.
Code instructions to receive a plurality of predicted outcomes each computed by applying an evaluated statistical model trained with the training set of a respective one the plurality of combinatorial train-test sets to the testing set of the respective combinatorial train-test set.
Code instructions to construct a plurality of virtual past time flows by aggregating the plurality of predicted outcomes.
Code instructions to estimate whether the evaluated statistical model applied with one or more rules is a false based on a distribution of performance scores computed on the plurality of virtual past time flows.

In a further implementation form of the first, second, third and/or fourth aspects, each of the plurality of predicted outcomes comprises a series of a plurality of partial predicted outcomes [each predicted outcome is a series of partial outcomes].

In a further implementation form of the first and/or second aspects, the correlation matrix is computed for the plurality of predicted outcomes after aligning together the series of the plurality of predicted outcomes computed by the plurality of statistical models.

In a further implementation form of the first and/or second aspects, the correlation matrix is computed based on pairwise alignment between each pair of the plurality of predicted outcomes by:
Computing a respective one of a plurality of covariances between the series of the partial predicted outcomes of a first predicted outcome of a respective pair and the series of the partial predicted outcomes of a second predicted outcome of the respective pair.
Computing a respective one of a plurality of variances for each of the plurality of predicted outcomes.
Computing the correlation matrix based on the plurality of covariances and the plurality of variances.

In a further implementation form of the first and/or second aspects, the alignment is based on time alignment of the plurality of predicted outcomes by:
Extracting a plurality of timestamps assigned to each of the plurality of partial predicted outcomes of each of the plurality of predicted outcomes.
Forming a unified timestamp comprising a plurality of timestamp indexes which is a union of the plurality of extracted timestamps.
Re-indexing the plurality of partial predicted outcomes of each of the plurality of predicted outcomes according to the unified timestamp.

In an optional implementation form of the first and/or second aspects, a zero value partial predicted outcome is filled in each timestamp index missing a respective partial predicted outcome identified in the series of each of the plurality of predicted outcomes.

In an optional implementation form of the first and/or second aspects, the plurality of partial predicted outcomes of each of the plurality of predicted outcomes are down-sampled to match a median annual frequency of the series of the plurality of predicted outcomes.

In an optional implementation form of the first and/or second aspects, the clustering is repeated with a plurality of initialization settings.

In a further implementation form of the first and/or second aspects, the plurality of statistical models correspond to a plurality of investment strategies trained based on backtesting of the plurality of past observations included in the historical dataset to compute predicted returns.

In a further implementation form of the third and/or fourth aspects, the purging is based on constructing the plurality of groups such that the respective subset of observations in the training set do not overlap in time with observations in the respective testing set.

In an optional implementation form of the third and/or fourth aspects, the purging is enhanced by inserting a predefined time margin between the respective subsets of observations of a group included in the training set and the subset of observations of a group included in the testing set such that observations identified in the predefined time margin are dropped from the training set.

In a further implementation form of the third and/or fourth aspects, the training set in each of the plurality of combinatorial train-test sets is the union of all training data sets after purging.

In a further implementation form of the third and/or fourth aspects, the evaluated statistical model corresponds to an investment strategy applied with one or more investment rules, the plurality of virtual past time flows are created based on backtesting of the time ordered observations included in the historical dataset.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of estimating a false positive probability of a statistical model selected from a plurality of statistical models based on clustering of the plurality of statistical models, according to some embodiments of the present invention;

FIG. 2 is a flowchart of an exemplary process of estimating a false positive probability of a statistical model based on distribution of performance computed for a plurality of virtual time flows, according to some embodiments of the present invention;

FIG. 3 is a schematic illustration of exemplary systems for estimating a false positive probability of a statistical model, according to some embodiments of the present invention;

FIG. 4 is a schematic illustration of an exemplary system for estimating a false positive probability of an investment strategy statistical model, according to some embodiments of the present invention;

FIG. 5 is a flowchart of an exemplary process of estimating a false positive probability of an investment strategy statistical model selected from a plurality of investment strategies based on clustering of the plurality of investment strategies, according to some embodiments of the present invention;

FIG. 6A and FIG. 6B present exemplary clustering schemes for clustering backtest trials simulating a plurality of investment strategies fitted on historical financial data to support estimation of a false positive probability of a selected investment strategy, according to some embodiments of the present invention;

FIG. 7 is a flowchart of an exemplary process of estimating a false positive probability of an investment strategy statistical model based on distribution of performance computed for a plurality of virtual time flows, according to some embodiments of the present invention; and

FIG. 8 is a graph chart of a plurality of observations of an equity price along a past time flow which are partitioned to groups, according to some embodiments of the present invention.

### DESCRIPTION OF SPECIFIC EMBODIMENTS OF THE INVENTION

The present invention, in some embodiments thereof, relates to detecting a false positive statistical model and, more specifically, but not exclusively, to detecting a false positive statistical model selected from a plurality of statistical models trained and tested on historical data.

Statistical models, for example, Machine Learning (ML) models and algorithms such as, for example, neural networks, Support Vector Machines (SVM) and/or the like may be highly useful to predict mapping (i.e., classify, cluster, label, etc.) of outputs for given inputs after training (fitting) the statistical models on training data (sample data).

Trained (and tested) with extensive and diverse training (and testing data), the statistical models may achieve high accuracy in estimating the mapping of new (unseen) data samples based on the patterns and inferences derived from fitting on the training data. However, training the statistical models with limited training data may present multiple concerns and pitfalls which may lead to identifying a low performing and potentially useless statistical model as a high performing model. In other words, a statistical model which presents high performance for mapping the training data (and potentially testing data) may in fact be a false positive (i.e., a false discovery) meaning that it may be useless for mapping data samples that are not identical or at least very similar to the training data. A false positive, also known as Type I error, occurs when a statistical model simulation (trial) rejects a true null hypothesis. The probability of obtaining a false positive may be defined by a significance level which is set to 5% for typical applications.

The probability of selecting false positive statistical models may be significantly high for applications in which the limited training data is composed of historical observations typically in a time order manner (thus forming a single past time flow) such as, for example, financial market behavior, human behavior, human masses behavior (e.g. historic processes, political processes, etc.) and/or the like. Due to the limited training data, training (and testing) the statistical models applied in such applications may typically comprise of multiple testing over the same limited training and testing data. As the limited training data is naturally shorter, multi-collinear, serially dependent, non-stationary and/or having lower signal to noise ratio, training and testing the statistical models in a plurality of simulations (trials, tests) using the same training (and testing) dataset may lead to Selection Bias under Multiple Testing (SBuMT) which may result in selecting false positive statistical models due to one or more biasing aspects inherent and/or imposed by SBuMT.

First, conducting a plurality of trials (simulations) using the same training data without adjusting the significance level accordingly may significantly increase the probability of obtaining a false positive statistical model since the significance level is not constant and increases when conducting more than one trial. Therefore applying the same rejection threshold (significance level) for the null hypothesis under multiple trials may grossly underestimate the probability of obtaining the false positive. Moreover, in many cases it may be impossible to adjust the rejection threshold due to selective reporting of the trials in which only the best performing statistical model trial(s) are reported while the multitude of other trials are not reported and may hence be unaccounted for and not be reflected in an adjustment to the rejection threshold.

Another biasing aspect rooted in conducting a plurality of trials (tests) using the same training data is over-fitting the statistical model(s) on the testing data since repeatedly training and testing the statistical model on the same dataset may yield highly statistical model(s) optimized for mapping the testing data and may hence present significantly reduced and/or limited accurately in mapping other (new) data samples which are not identical or at least very similar to the training data.

Moreover, the over-fitting of the statistical model may be further increased and potentially is unidentified in case the testing data used to test the trained statistical model is linked (correlated) to the training data.

Furthermore, as the number of the plurality of trials conducted to train and test the statistical model(s) may be extremely large, the trials may be interdependent such that while the overall number of trials may be very high, the number of independent trials may be relatively small thus further exposing the selection of the statistical model to be false positive.

Another limitation resulting from the SBuMT may relate to storytelling in which a story may be constructed retroactively to justify a false positive high-performing statistical model based on one or more detected patterns which may in fact be random pattern(s) and hence inapplicable for future predictions. Another concern may relate to selecting a false positive high-performing statistical model based on one or more outliers comprising one or more extreme outcomes (returns) computed for the testing data which may be useless for future predictions since the past observations documented in the training dataset may never repeat in the future.

As stated herein above, the statistical models may be applied for financial modeling applications such as, for example, fabricating, identifying and/or selecting investment strategies. Since experimental training data may be unavailable for training and testing the statistical model, backtesting which is an essential tool in quantitative financial modeling is applied for these financial modeling applications. The backtesting comprises simulations of how an investment strategy (investment portfolio) would have performed under a particular historical scenario, i.e., should the investment strategy have been run over a past period. Backtesting is conducted by applying the investment strategies statistical models on the historical data which comprises past financial observations of one or more financial markets, for example, the stock exchange, the commodities exchange, the currency rates, trading trends and conditions, state and government financial data and/or the like. The backtesting is therefore an actualization of only one path since changing the financial environmental inputs (past observations) is impossible.

The performance of an investment strategies simulated by the backtesting may often be measured in terms of the Sharpe Ratio (SR) which has become de facto the most popular investment performance metric. The distributional properties of the SR are well-known, allowing researchers to use this statistic to test of profitability of an investment strategy for a given confidence level.

Such investment strategies statistical models may be susceptible to further biasing aspects. The further biasing may include, for example, a survivor bias which considers investment strategies predicted outcomes (predicted returns) which relate to companies, entities, securities and/or the like which are still active in the current financial market while ignoring others which have since disappeared, for example, companies which went bankrupt, securities which were delisted and/or the like. In another example, the biasing may include a look-ahead bias which includes applying the tested investment strategies to information which was not known at the time of the past observations such that the prediction of the investment strategies may not accurately reflect the estimated past outcome since new information is used for the training and/or testing. In another example, the biasing may result from a difficulty and possibly inability to simulate transaction costs since the only way to get accurate transactions costs is to interact with the trading book, i.e. to do the actual trade which is naturally impossible for a simulation of the past. In another example, the biasing may result from taking a short position on cash products which may require finding a lender. The cost of lending and the amount available may be difficult to accurately simulate since this information is generally unknown as it may depend on relations, inventory, relative demand and/or the like which may be unknown during the simulation.

According to some embodiments of the present invention, there are provided methods and systems for estimating whether a statistical model selected from a plurality of statistical models trained using observed historical data is a false positive based on clustering the plurality of statistical models (trials) to several clusters of fundamentally independent statistical models and estimating a false positive probability of the cluster comprising the selected statistical model. The computed false positive probability may be highly indicative of the extent to which the selected statistical model is over-fit on the testing set.

The plurality of statistical models is applied on a dataset, specifically a limited historical dataset comprising a plurality of past observations to compute respective predicted outcomes.

A correlation matrix is computed for the plurality of statistical models based on the predicted outcomes computed by the statistical models. The predicted outcome computed by each of the statistical models comprises a series of partial predicted outcomes which may be aligned with each other, for example, time ordered and/or the like. The correlation matrix is indicative of the inter-dependence and/or correlation between the predicted outcomes and may hence be highly indicative of the inter-dependence and/or correlation between the respective statistical models.

Using a distance metric applied to the correlation matrix, the plurality of aligned predicted outcomes may be clustered to a plurality of clusters according to a plurality of clustering schemes each defining a different number of clusters. Based on a quality score computed for each clustering scheme the clustering scheme having the highest quality score is selected.

An aggregated predicted outcome is computed for each of the clusters of the selected clustering scheme by aggregating the predicted outcomes of all the statistical models contained (clustered) in the respective cluster. Moreover, a variance computed across the plurality of clusters of the selected clustering scheme based on a variance between the aggregated predicted outcomes of the clusters.

The probability of the selected statistical model being a false positive may be then computed based on the aggregated predicted outcome of the cluster comprising the predicted outcomes of the selected statistical model, the variance computed across the clusters and the number of clusters.

For example, assuming the plurality of statistical models includes a plurality of investment strategies trained (fitted) using the limited training dataset, specifically the limited financial historical data comprising the past financial observations. In such case, the probability of the selected investment strategy being a false positive may be computed based on a Deflated Sharpe Ratio (DSR) computed for the cluster comprising the predicted returns of the selected investment strategy which is computed to compensate for the fact that multiple investment strategies (trials) are executed using the same training dataset. The DSR of the cluster of the selected investment strategy (designated selected cluster herein after) may be computed according to a Cumulative Distribution Function (CDF) applied on the SR of the aggregated predicted return of the selected cluster compared to a maximal (sheer luck) SR of the predicted returns of all investment strategies. The CDF may be further adjusted according to one or more parameters of the distribution of the plurality of predicted outcomes computed by respective investment strategies to further increase the confidence of the false positive probability estimated for the selected investment strategy.

Estimating the false positive probability of the selected based on the clustering of the plurality of statistical models may present major advantages and benefits. First, clustering the plurality of statistical models to the clusters may identify the group of basic independent and uncorrelated statistical models thus significantly reducing and potentially eliminating correlation and/or interdependence between the clusters. This in turn significantly increases the confidence in the computed false positive probability since correlation and/or interdependence may not distort or at least not significantly distort the computation. Moreover, reducing the overall number of statistical models to the few clusters may allow compensating for the multiple testing and the significance level may be adjusted to reflect the number of basic independent and uncorrelated statistical models. Furthermore, computing the estimated false positive probability for the selected statistical model may therefore utilize significantly reduced computing resources (e.g. processing power, processing time, storage resources, etc.) compared to computing the false positive probability with respect to all the other statistical models.

According to some embodiments of the present invention, there are provided methods and systems for estimating whether a selected statistical model applied with one or more rules is a false positive by expanding the limited training (and testing) dataset to prevent overfitting of the selected statistical model to the limited training dataset. This is done by re-constructing the a limited historical dataset which corresponds to a single (historical) past time flow to create a plurality of virtual past time flows and estimating the performance of the selected statistical model for the plurality of virtual past time flows. Specifically the virtual past time flows are created by aggregating predicted outcomes computed by the statistical model applied on testing data which is purged from any correlation with the training data used to fit (train) the statistical model thus preventing correlation between the training dataset and the testing dataset.

The limited historical dataset which comprises a plurality of past observations ordered in time according to the past time flow is first partitioned to a plurality of groups each comprising a respective subset of the past observations.

Using the plurality of groups a plurality of combinatorial train-test sets each comprising a unique combination of training groups and testing groups. In particular, the testing groups and training groups in each of the combinatorial train-test sets are at least partially purged from mutual information with each other thus preventing data leakage between the training and testing groups. For example, as the groups comprise different subsets of the past observations the groups may be uncorrelated in time. Moreover, in order to further ensure no data is leaked between groups, an “embargo” time margin may be optionally inserted between testing and training groups comprising subsequent past observations such that past observations identified in the embargo” time margin are dropped from the training set.

The selected statistical model may be fitted (trained) and tested using the plurality of purged combinatorial train-test sets in a process designated herein after by the term Combinatorially Purged Cross Validation (CPCV) process. During the CPCV process, the selected statistical model computes a plurality of predicted outcomes for the plurality of combinatorial train-test sets. Since each of the combinatorial train-test sets includes a unique combination of the groups arranged in past time order, the predicted outcomes computed for each combinatorial train-test set may be regarded as a unique past time flow.

The predicted outcomes computed by the selected statistical model for the plurality of combinatorial train-test sets may be therefore aggregated to create a plurality of virtual past time flows.

The performance of the selected statistical model may be then computed based on the predicted outcomes computed by the selected statistical model applied with one or more of the rules (e.g. investment strategy rules) for the plurality of virtual past time flows.

The false positive probability of the selected statistical model may be estimated based on the performance distribution identified across the plurality of virtual past time flows.

Estimating the false positive probability of the selected based on the performance distribution computed for the selected statistical model for each of the plurality of virtual past time flows may present major advantages and benefits. First, applying the CPCV may ensure testing the evaluated statistical model out-of-sample thus significantly reducing the risk for testing the selected statistical model using testing data that is correlated to the training data on which the selected statistical model is fitted (trained). This may eliminate the risk of selecting a false positive statistical model which naturally performs well on testing data that is highly correlated to the training data. Moreover, by creating the plurality of virtual past time flows, the limitation of testing the selected statistical model along the single actual past time flow is overcome as the selected statistical model may be tested for the multitude of virtual past time flows. In addition, the performance testing may be done for equal size virtual past time flows thus making the results easily comparable and assessable. Also, every past observation is part of one and only one testing group and since no warm-up may be requiring no, the limited historical dataset may be arranged to create the longest possible virtual past time flows.

According to some embodiments of the present invention, there are provided methods, systems and frameworks for logging and tracking of all the statistical models simulations (trials) to increase the accuracy of the false positive probability estimation. To this end the framework may apply means for verifying several properties for each of the plurality of statistical models simulations (trials). One of these properties is completeness to ensure that every trial backtest conducted on the historical data is recorded and tracked and verify security of the backtests such that the predicted outcomes may not be manipulated and/or deleted. Another property is coerciveness to ensure that all backtests are logged into the system by automatically recording and curating every trial conducted in the system. Another property is purity of the trials which may be enforced based on pre-approval of the logged backtests by one or more authorities, for example, a Research Committee in order to prevent external and/or unapproved investment strategies from contaminating the trials conducted internally. Another property is consistency of the execution methodology(s) and performance metrics used under for all of the trials, both metrics applicable to individual trials as well as metrics adjusted for SBuMT.

Conducting the statistical models simulations under a well-defined and strictly maintained framework may enable traceability, integrity, completeness and purity of all trials. This may allow accounting and compensating for the SBuMT in order to significantly reduce and potentially prevent all together the effects of the SBuMT biases. As such the false positive probability estimation conducted for one or more of the tested statistical models may be significantly more accurate to reflect realistic performance of the selected statistical models in the future. This may be of particular benefit for increasing the accuracy and integrity of the false positive probability evaluated for the investment strategies which may inherently be highly susceptible to many of the SBuMT biasing aspects.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer Program code comprising computer readable program instructions embodied on a computer readable medium may be transmitted using any appropriate medium, including but not limited to wireless, wire line, optical fiber cable, RF, etc., or any suitable combination of the foregoing.

The program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code can be downloaded to respective computing/processing devices from a computer readable storage medium or to an external computer or external storage device via a network, for example, the Internet, a local area network, a wide area network and/or a wireless network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

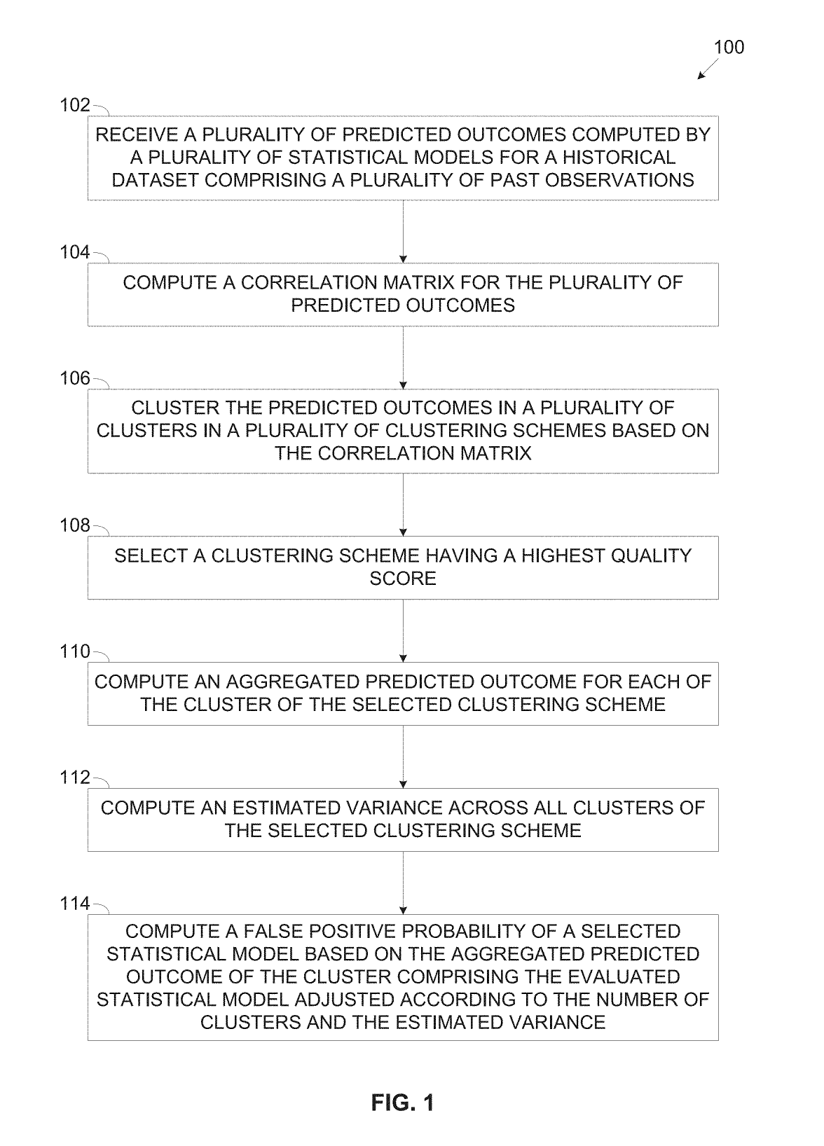

Referring now to the drawings, FIG. 1 is a flowchart of an exemplary process of estimating a false positive probability of a statistical model selected from a plurality of statistical models based on clustering of the plurality of statistical models, according to some embodiments of the present invention. An exemplary process 100 may be executed for estimating a false positive probability of a statistical model, for example, a machine learning model (e.g. neural network, SVM, etc.) selected from a plurality of statistical models trained using a limited dataset. In particular, the limited dataset includes historical data comprising a plurality of past observations. The false positive probability is estimated based on clustering the plurality of statistical models (trials) to several clusters of fundamentally independent statistical models and estimating a false positive probability of the cluster comprising the selected statistical model.

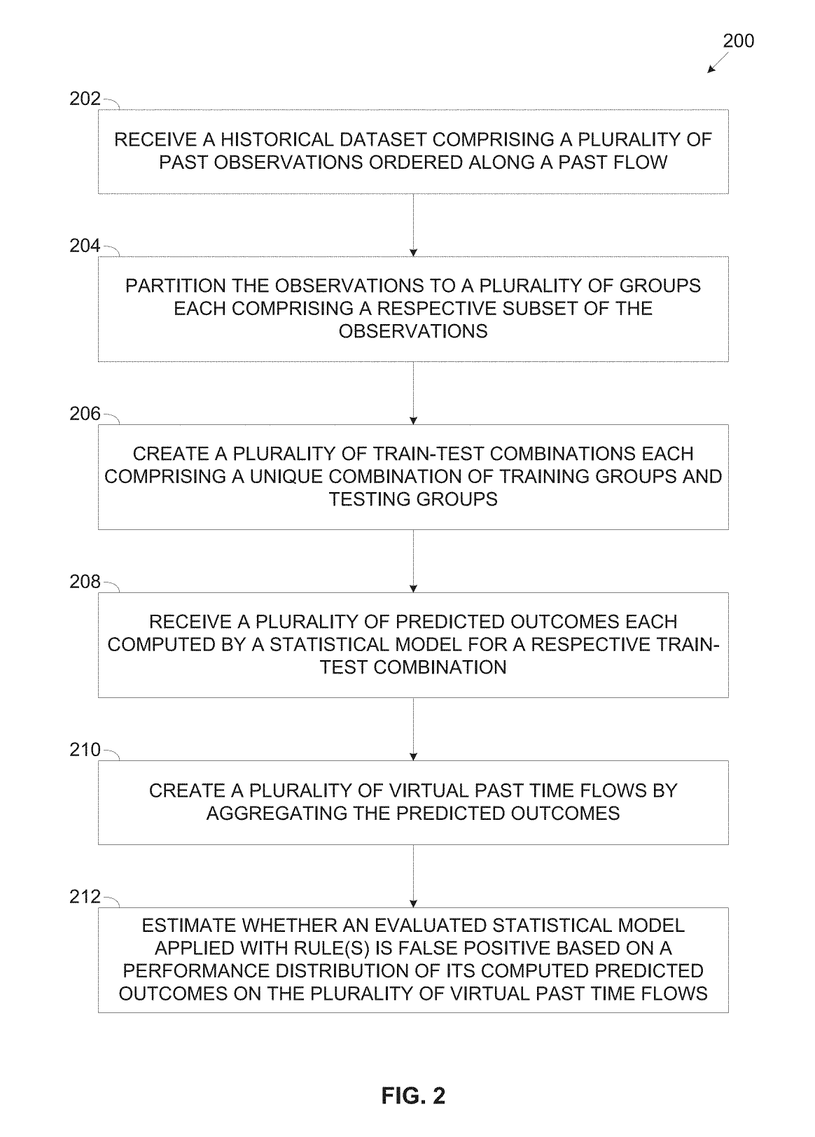

FIG. 2 is a flowchart of an exemplary process of estimating a false positive probability of a statistical model based on distribution of performance computed for a plurality of virtual time flows, according to some embodiments of the present invention. An exemplary process 200 may be executed for estimating a false positive probability of an evaluated statistical model applied with one or more rules by evaluating the performance distribution of the evaluated statistical model for a plurality of virtual past time flows. The plurality of virtual past time flows are created by aggregating predicted outcomes computed by the evaluated statistical model for a plurality of combinatorial train-test sets each comprising a unique combination of training and testing groups each comprising a respective subset of past observations included in a historical dataset.

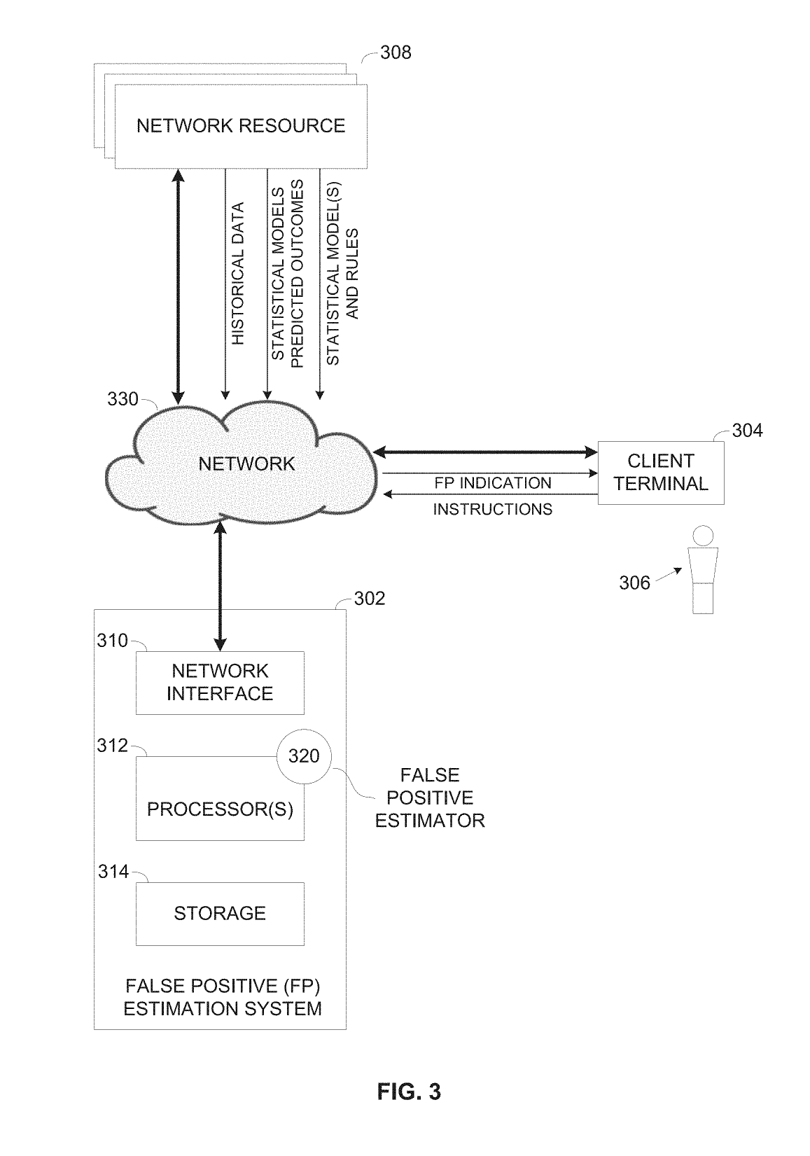

Reference is also made to FIG. 3, which is a schematic illustration of exemplary systems for estimating a false positive probability of a statistical model, according to some embodiments of the present invention. An exemplary false positive (FP) estimation system 302 may be used for executing the process 100 and/or the process 200 for estimating a false positive probability of a statistical model selected under multiple testing from a plurality of statistical models trained with limited historical data. The FP estimation system 302, for example, a computer, a server, a computing node, a cluster of computing nodes and/or the like may include a network interface 310, a processor(s) 312 for executing the process 100 and/or 200 and a storage 314 for storing data and code (program store).

The network interface 310 may include one or more wired and/or wireless interfaces for connecting to a network 330 comprising one or more wired and/or wireless networks, for example, a Local Area Network (LAN), a Wide Area Network (WAN), a Metropolitan Area Network (MAN), a cellular network, the internet and/or the like. Using the network interface 310 the FP estimation system 302 may communicate, via the network 330, with one or more remote network resources 308, for example, a server, a computing node, a storage server, a networked database, a cloud service and/or the like. Through the network 330 the FP estimation system 302 may further communicate with one or more client terminals 304, for example, a computer, a server, a laptop, a mobile device and/or the like used by respective users 306.

The processor(s) 312, homogenous or heterogeneous, may include one or more processing nodes arranged for parallel processing, as clusters and/or as one or more multi core processor(s). The storage 314 may include one or more non-transitory persistent storage devices, for example, a hard drive, a Flash array and/or the like. The storage 314 may also include one or more volatile devices, for example, a Random Access Memory (RAM) component and/or the like. The storage 314 may further comprise one or more local and/or remote network storage resources, for example, a storage server, a Network Attached Storage (NAS), a network drive, a cloud storage service and/or the like accessible via one or more networks through the network interface 310.

The processor(s) 312 may execute one or more software modules such as, for example, a process, a script, an application, an agent, a utility, a tool, an Operating System (OS) and/or the like each comprising a plurality of program instructions stored in a non-transitory medium (program store) such as the storage 314 and executed by one or more processors such as the processor(s) 312. In particular, the processor(s) 212 may execute a False Positive (FP) estimator software module 320 for executing the process 100 and/or 200 to estimate a false positive probability of a statistical model selected under multiple testing from a plurality of statistical models.

Optionally, the FP estimation system 302, specifically the FP estimator 320 are utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2) and/or the like.

The FP estimator 320 communicating with the network resource(s) 308, for example, a storage platform, a statistical models testing platform and/or the like may receive data essential for executing the process 100 and/or 200, for example, historical data, statistical models (trials), predicted outcomes computed by statistical models, execution rules for the statistical models and/or the like.

One or more of the client devices 304 may execute one or more applications, services and/or tools for communicating with the FP estimation system 302 and more specifically with the FP estimator 320 in order to enable the user 306 to interact with the FP estimator 320. For example, the client terminal 304 may execute a web browser for communicating with the FP estimator 320 and presenting a User Interface (UI), specifically a Graphical UI (GUI) which may be used by the user 306 to interact with the FP estimator 320. In another example, the client terminal 304 may execute a local agent which communicates with the FP estimator 320 and presents a GUI which may be used by the user 306 to interact with the FP estimator 320.

The interaction of the user 306 with the FP estimator 320 may include, for example, receiving a false positive (FP) indication for one or more statistical models evaluated by the FP estimator 320. In another example, the user may interact with the FP estimator 320 to provide the FP estimator 320 one or more instructions for executing the process 100 and/or 200. For example, the user 306 may provide to the FP estimator 320 one or more statistical models which are stored and/or developed on the client terminal 304. In another example, the user 306 may provide to the FP estimator 320 one or more rules, specifically configuration rules stored and/or developed on the client terminal 304 for configuring one or more of the statistical models evaluated by the FP estimator 320 in the process 100 and/or 200.

As stated herein before, the process 100 executed by the FP estimator 320 is directed to estimate the false positive probability of a statistical model selected from a plurality of statistical models fitted to the limited dataset based on clustering the plurality of statistical models simulations (trials) and estimating the false positive probability of the cluster comprising the selected statistical model.

As shown at 102, the process 100 starts with the FP estimator 320 receiving a plurality of predicted outcomes computed by a plurality of statistical models for a historical dataset comprising a plurality of past observations. The statistical models, for example, machine learning models and/or algorithms such as, for example, neural networks, SVMs and/or the like may be trained (fitted) using at least some of the historical dataset and compute the predicted outcomes for at least another part of the historical dataset. In particular, the historical dataset may be limited as it may include past observations which may not be manipulated and/or synthetically created.

Each of the predicted outcomes computed by the plurality of statistical models may typically include a series of partial predicted outcomes which may be ordered according to one or more ordering schemes, for example, time and/or the like.

A shown at 104, the FP estimator 320 may compute a correlation matrix for the plurality of predicted outcomes thus identifying a correlation between the plurality of statistical models.

As the predicted outcomes are computed by different statistical models applying different computation schemes and rules, the received predicted outcomes may comprise partial predicted outcomes which are ordered differently. The FP estimator 320 may therefore first align the series of partial predicted outcomes of at last some of the plurality of received predicted outcomes with each other in order to efficiently create the correlation matrix. The FP estimator 320 may apply one or more methods for aligning the predicted outcomes and computing the correlation matrix.

For example, the FP estimator 320 may apply a pairwise alignment between the series of partial predicted outcomes of each pair of predicted outcomes computed by a respective pair of statistical models. The FP estimator 320 may compute a covariance between the series of partial predicted outcomes of each pair predicted outcomes and may repeat the computing for all pairs of predicted outcomes to produce a plurality of covariances (values). The FP estimator 320 may further compute a variance for each of the statistical models. The FP estimator 320 may then compute an aggregated covariance matrix based on the plurality of covariances computed for each pair of predicted outcomes and the variances computed for each predicted outcome.

In another example, the FP estimator 320 may apply a multi-variant alignment between the series of partial predicted outcomes of the plurality of predicted outcomes by aligning the plurality of predicted outcomes according to a common time line constructed of a unified timestamp index. As stated herein before, at least some of the predicted outcomes may be ordered in different order, specifically in time such that the partial predicted outcomes in the series defined by these predicted outcomes correspond to different times (timestamps). The FP estimator 320 may therefore extract the timestamps from all partial predicted outcomes of all of the predicted outcomes and unify them to create a unified timestamp index comprising all the time stamps indicated in all series of all of the predicted outcomes. The FP estimator 320 may then re-index the partial predicted outcomes in the series of at least some of the predicted outcomes according to the unified timestamp index to align these predicted outcomes along a unified timeline.

Naturally, the unified timestamp index includes more timestamps than the timestamps identified for the partial predicted outcomes in the series of at least some of the predicted outcomes. Therefore, after the FP estimator 320 re-indexes the series of partial predicted outcomes of such predicted outcomes there will be one or more empty timestamp entries in which respective partial predicted outcomes are missing. In order to ensure proper alignment, the FP estimator 320 may fill such empty timestamp entries with zero value partial predicted outcomes.

In some case it may be desirable and/or preferable to align the predicted outcomes in for a certain period of time, for example, a second, a minute, an hour, a day, a week, a month, a quarter, a year and/or the like. The FP estimator 320 may therefore consolidate, for example, annualize the predicted outcomes to produce annual predicted outcomes by down-sampling the plurality of partial predicted outcomes in the series of each of the plurality of predicted outcomes to match a median annual frequency of the series of the plurality of predicted outcomes. After aligning the predicted outcomes according to the unified timestamp index, the FP estimator 320 may compute multi-variances (values) for the plurality of predicted outcomes and may further compute the covariance between each pair of predicted outcomes based on the multi-variances (values).

After aligning the predicted outcomes according to one or more of the alignment methods the FP estimator 320 may compute an aggregated covariance matrix C aggregating the plurality of covariances computed for the pairs of predicted outcomes. Based on the aggregated covariance matrix C, the FP estimator 320 may then compute the correlation matrix p for the plurality of predicted outcomes which naturally reflects the correlation between the statistical models which computed the predicted outcomes.

However, it is important to note that the aggregated covariance matrix C that is evaluated by the FP estimator 320 may not necessarily be a proper covariance matrix, in the sense that it might not necessarily be positive definite. To ensure the positive definite property, the FP estimator may evaluate the smallest eigenvalue A of the aggregated covariance matrix C. In case A<0, then the FP estimator 320 may adjust the aggregated covariance matrix C as follows C=C−(λ−ε)I, where I is the identity matrix and ε>0 is sufficiently large to create a respective adjusted correlation coefficient (SCC) correlation matrix which thus preventing a numerically ill-conditioned correlation matrix. This ensures that the aggregated covariance matrix C is positive definite. If further enhancement of the robustness of this aggregated covariance matrix C is required, the FP estimator 320 may utilize one or more enhancement procedures, for example, the Ledoit-Wolf shrinkage procedure and/or the like.

As shown at 106, the FP estimator 320 may cluster the plurality of predicted outcomes in a plurality of clusters based on the computed correlation matrix. Moreover, in order to identify the most effective clustering implementation which best allocates the plurality of predicted outcomes to fundamentally independent clusters, the FP estimator 320 may attempt to cluster the plurality of predicted outcomes according a plurality of clustering schemes each defining a different number k of clusters which is lower than the number of statistical models N and their respective N predicted outcomes, such that k=2, 3, 4, . . . K where K<N.

To this end, the FP estimator 320 may compute a distance matrix

$${D}_{i , j} = \sqrt{\{ \frac{1}{2} ( 1 - {ρ}_{ij} ) \}}$$

for i,j=1, . . . , N. By design, a pair of statistical models i and j with high correlation, i.e. when ρ_{i,j} is significantly low (e.g. close to 1) will be “near” each other such that D_{i,j} is significantly low (e.g. close to 0). This definition of distance is a proper metric in the sense that it satisfies the four classical axioms: Non-negativity, identity, symmetry and sub-additivity.

Furthermore, a more global distance rather than local distance may be preferable for improved clustering. Therefore, the FP estimator 320 may compute a Euclidean distance matrix \tilde{D} for clustering the predicted outcomes where \tilde{D}_{i,j}=\sqrt{Σₖ(Dᵢₖ−Dⱼₖ)²} to incorporate global distances and thus reducing noise.

Using D and assuming k clusters, the FP estimator 320 may apply one or more clustering algorithms, for example, spectral co-clustering (a form of bi-clustering), K-means clustering and/or the like to cluster the plurality of predicted outcomes to a plurality of clusters k for each of the clustering schemes.

Optionally, the FP estimator 320 repeats the clustering process with a plurality of different initialization settings for the clustering algorithm(s) which may improve the clustering results.

A shown at 108, the FP estimator 320 may select a clustering scheme which is the most effective clustering implementation in which the plurality of predicted outcomes are best allocated to distinct clusters. In order to identify the most effective clustering scheme, the FP estimator 320 may compute a quality score q for each of the clustering schemes and select the clustering scheme which achieves a highest quality score among the plurality of quality scores computed for the plurality of clustering schemes.

The FP estimator 320 may compute the quality score q for each of the clustering schemes based on a silhouette score computed across the clusters of the respective clustering scheme. The silhouette score is a measure of how similar an object (in this case a predicted outcome) is to its own cluster (cohesion) compared to other clusters (separation). In particular, the FP estimator 320 may compute the quality score q as the average silhouette score across the k clusters of each clustering scheme divided by the standard deviation of the predicted outcomes which may be formulated as q=E[scores]/\sqrt{{V[scores]}}.

The FP estimator 320 may then select the clustering scheme having the highest quality score q. As the plurality of predicted outcomes N are clustered in a reduced number of clusters K where K<<N, the dimensionality of the space may be significantly reduced to K fundamentally different statistical models which are substantially uncorrelated with each other.

As shown at 110, the FP estimator 320 may compute an aggregated predicted outcome for each of the k clusters of the selected clustering scheme. The aggregated predicted outcome of each cluster aggregates the predicted outcomes clustered in the respective cluster.

As shown at 112, the FP estimator 320 may compute an estimated variance across the k clusters of the selected clustering scheme.

As shown at 114, the FP estimator 320 may compute a false positive probability of one more statistical models selected from the plurality of statistical models. The FP estimator 320 may compute the false positive probability of an evaluated statistical model based on the aggregated predicted outcome of the cluster comprising the predicted outcome computed by the selected statistical model adjusted according to the number k of clusters in the selected clustering scheme and the estimated variance across all clusters of the selected clustering scheme.

The FP estimator 320 may then output, transmit, deliver and/or provide the false positive probability estimated for the selected statistical model to one or more of the users 306 which may use the estimated false positive probability to assess whether and how to employ the selected statistical model.

As stated herein before, the process 200 executed by the FP estimator 320 is directed to estimate the false positive probability of an evaluated statistical model applied with one or more rules by evaluating the performance distribution of the evaluated statistical model for a plurality of virtual past time flows.

As shown at 202, the process 100 starts with the FP estimator 320 receiving the historical dataset comprising the plurality of past observations ordered along a (historical) past time flow.

As shown at 204, the FP estimator 320 may partition the plurality of past observations to a plurality of groups such that each group comprises a respective subset of the plurality of past observations documenting a segment of the past time flow. Moreover, since the groups may be used for training and testing a statistical model, in order to prevent data leakage between groups the FP estimator 320 may create the groups such that each observation may be included in only a single group and the subset of observations in each group comprises subsequent observation along the past time flow. As such none of the groups may overlap in time with any other group and the groups are hence purged from mutual information.

As shown at 206, the FP estimator 320 may create a plurality of combinatorial train-test sets. Each of the combinatorial train-test sets includes the plurality of groups arranged in a unique training-testing split between testing groups and training groups. As such, the FP estimator 320 constructs the combinatorial train-test sets to include a testing set which comprises one or more of the groups and a training set which includes all the other groups which are not included in the testing set.

As the FP estimator 320 originally constructed the groups include different subsets of the observations, the testing set of each of the combinatorial train-test sets is purged from mutual information and data leakage to the training set of the respective combinatorial train-test set.

Optionally, the FP estimator 320 further enhances the purging of the groups of the testing set from mutual information with groups of the training set by inserting a predefined time margin (‘embargo”) between the respective subsets of observations of the groups included in the training set and the observations of group included in the testing set. As such, observations which are identified in the predefined time margin are dropped from the training set.

The FP estimator 320 may construct the training set of each of the plurality of combinatorial train-test sets as the union of all training data sets after purging the mutual information between the groups.

As shown at 208, the FP estimator 320 may receive a plurality of predicted outcomes which are computed by an evaluated statistical model simulated using the plurality of combinatorial train-test sets. Each of the predicted outcomes is computed by training (fitting) the evaluated statistical model using the training set of a respective one the plurality of combinatorial train-test sets and applying the trained evaluated statistical model on the testing set of the respective combinatorial train-test set.

As shown at 210, the FP estimator 320 may create a plurality of virtual past time flows by aggregating the plurality of predicted outcomes.

As shown at 212, the FP estimator 320 may estimate whether the evaluated statistical model applied with one or more rules is false positive based on a distribution of performance scores computed on the plurality of virtual past time flows.

The FP estimator 320 may further output the predicted outcomes, the evaluated performance and/or the false positive indication and/or probability. For example, the provided data, specifically the predicted outcomes may be displayed in a histogram and used to gauge the efficacy of the statistical model applied with the rule(s).

It should be noted that the predicted outcomes computed by the evaluated statistical model are, by design, tested out-of-sample and trained using curated data throughout time. The distribution of the predicted outcomes may be stress tests of the rule R and the evaluated statistical model.

According to some embodiments of the present invention the FP estimation system 302 and the FP estimator 320 executing the process 100 and/or 200 are applied for estimating the false positive probability of an investment strategy statistical model selected from a plurality of investment strategy statistical models. The plurality of investment strategy statistical models may be fitted (trained) on historical financial data which by its nature is very limited since it may include a plurality of past financial observations documenting a single past time flow. The selection of the investment strategy statistical model which may present high performance for the past time flow may be affected by one or more of the SBuMT biasing aspects and may thus be ineffective future financial scenarios and in many cases may be practically useless and even destructive.

As such, the FP estimation system 302 and the processes 100 and 200 described herein before are demonstrated in further detail for the investment strategy statistical models embodiments.

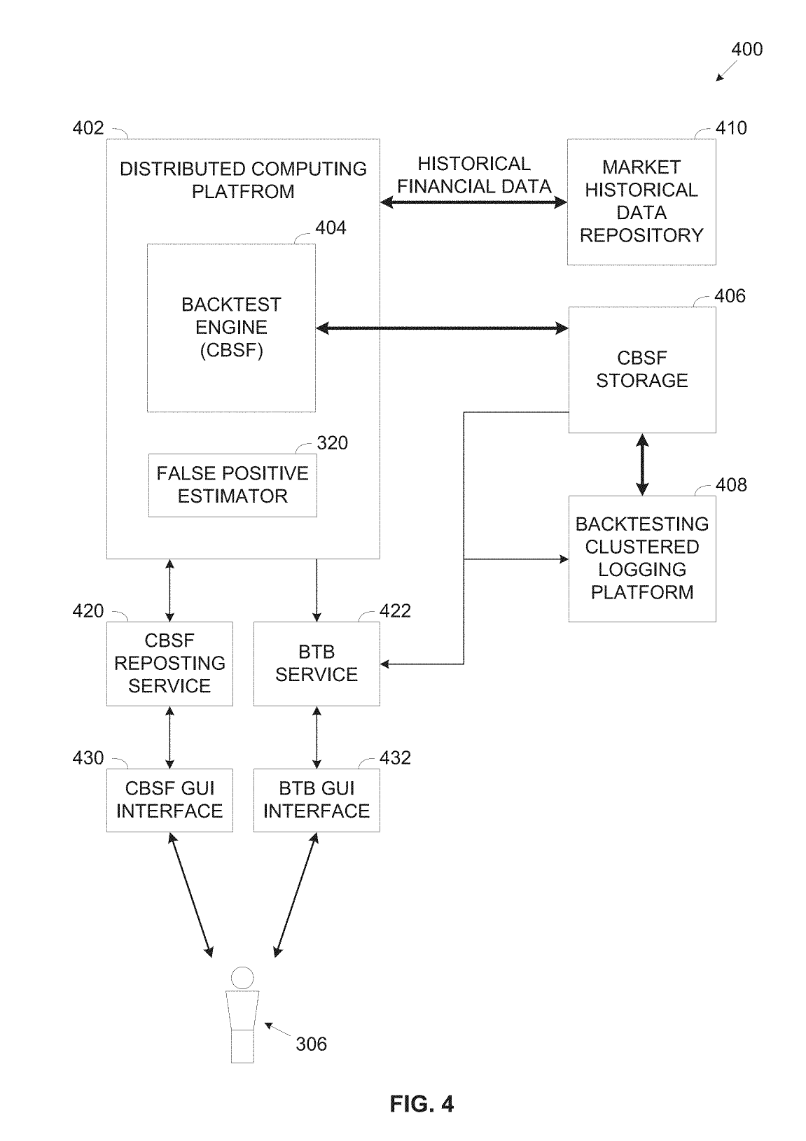

Reference is now made to FIG. 4, which is a schematic illustration of an exemplary system for estimating a false positive probability of an investment strategy statistical model, according to some embodiments of the present invention. An exemplary system 400 may be deployed to facilitate an FP estimation system such as the FP estimation system 302 executing an FP estimator such as the FP estimator 320. In particular, the system 400 is directed to provide infrastructure and framework for estimating a false positive probability of one or more investment strategies statistical models selected based on backtesting, i.e. statistical models simulations (trials) applied on limited historical data, specifically historical financial data.

The system 400 operates under several strictly defined frameworks to support the false positive estimation by sandboxing (logging and tracking) the backtests (trials), i.e., the statistical models simulations and collecting metadata relating to each trial so that the probability of a false discovery may be evaluated. The frameworks under which the system 400 operates are directed to ensure that the backtests comply with several properties essential for estimating the false positive probability of selected investment strategy(s), for example:
Completeness to ensure that every backtest conducted on the historical financial data is recorded and tracked and verify security of the backtests such that the predicted outcomes (i.e., predicted returns) of the logged backtests may not be manipulated and/or deleted.
Coerciveness to ensure that all backtests are logged in the system 400 and there is no way to choose which backtests are logged and which are not. The meta-data of the backtests execution may be automatically recorded for each backtest trial and curated in the system to prevent bias.
Purity of the backtesting trials which may be enforced based on pre-approval of the logged backtests by one or more authorities, for example, a Research Committee in order to prevent external and/or unapproved investment strategies from contaminating the backtest trials conducted in the system 400.
Consistency of the backtests execution methodology(s) and metrics used under the framework of the system 400 based on computation and application of common and consistent performance metrics applicable to individual backtest trials as well as performance metrics adjusted for SBuMT.

The system 400 may provide one or more users such as the user 306, for example, an investment professional, a senior management person and/or the like with the ability to sift through a variety of backtesting trials and search for investment strategies that may suit a client's investment needs. The system 400 may also provide users 306, for example, a manager and/or the like the ability to evaluate performance of one or more research employees which devised one or more of the tested investment strategies in order quantify their ability to derive unique uncorrelated investment strategies.

The software components executed in the system 400 may be implemented using one or more programming methods, tools, frameworks and/or the like, for example, using the Python programming language which may run on the 2.7× series interpreters and/or 3^{rd} party modules.

The system 400 may include a distributed computing system 402 comprising a plurality of distributed computing nodes (e.g. servers, cloud computing services, etc.) executing under a distributed computing framework defining infrastructures, methods and/or protocols for distributed computing. For example, the distributed computing system 402 may employ the Celery Distributed Task Queue software which provides native compatibility with Python and is suited for near real-time message processing. The distributed computing system 402 may employ one or more mechanisms, protocols and/or methods for balancing the workload across the plurality of computing nodes.

The distributed computing system 402 may connect to a market historical data repository 410 which stores historical financial data comprising a plurality of past financial observations of one or more financial markets, for example, the stock exchange, the commodities exchange, the currency rates, trading trends and conditions, state and government financial data and/or the like. The financial observations which may be applicable for one or more trading instruments may be used for backtesting, i.e., simulating the investment strategies. The distributed computing system 402 may collect the historical financial data from the market historical data repository 410 via a market data service which may employ one or more protocols and/or frameworks for disseminating the historical financial data over a messaging framework, for example, the RabbitMQ message-broker and/or the like.

The distributed computing system 402 may execute a backtest engine 404 for conducting backtest trials (i.e., investment strategies simulations) under a Central Backtesting and Surveillance Framework (CBSF). The backtest engine 404 may execute a plurality of backtest trial jobs in which the investment strategies may be simulated (trained and tested) using the historical financial data. Each backtest trial job may be assigned a Unique Trial Identifier (UTID) to support tracking of the trial jobs throughout the system 400. The distributed computing system 402 may present major advantages for executing the backtest engine 404 as multiple backtest trials jobs (i.e., investment strategies simulations) may be executed simultaneously (in parallel) by the multiple distributed computing nodes thus significantly reducing the duration of the backtesting session which encompass an extremely large number of backtest trial jobs each involving processing large amounts of historical financial data.

The backtest engine 404 may further calculate performance metrics that may be used to control and compensate for the SBuMT biasing effects. The backtest engine 404 executing the backtest trials (i.e., the investment strategies simulations) may compute one or more of a plurality of performance statistics for the predicted returns (predicted outcomes) computed by the simulated investment strategies. Such performance statistics may include, for example, Annualized Rate of Return (aRoR), Percentage Maximum drawdown (MDD), Time under Water (TuW), Gini Coefficient (Gini), Effective Number (ENum), Correlation to benchmark (Con), Active Returns (AR), Tracking Error (TE) and Sharpe Ratio (SR) or Information Ratio (IR) and/or the like as applicable for the simulations.

The backtest engine 404 executing under the CBSF framework may decompose the allocations, returns, risk exposures and/or the like to provide a consistent view of the simulated investment strategies. For each backtest trial set, the backtest engine 404 may pre-compute and generate one or more reports required for calculating the false positive probability of the respective simulated investment strategy. The reports may be further adjusted to reduce and potential eliminate the effects of the SBuMT bias(s).

The backtest engine 404 may be supported by a CBSF storage 406 which may be configured for efficient, robust and persistent storage of data which may be essential for a backtesting system in which every data point must be recorded and retrieved quickly. The CBSF storage 406 may include a plurality of data stores employing one or more storage technologies, platforms and/or systems to support the backtest engine 404 with efficient and persistently secure storage and optionally provide data redundancy. For example, the CBSF storage 406 may include an HDF5 based data store which may be used for ad-hoc fast lookups from the file system. The HDF5 may be significantly simple thus making it convenient for deployment and highly portable between systems. In another example, the CBSF storage 406 may include one or more in-memory databases used for fast lookups, for example, VoltDB which is a fast in-memory database providing SQL capabilities, Redis which is a fast in-memory Non-SQL database used for structuring data specific use-cases and/or the like. In another example, the CBSF storage 406 may include one or more PostgreSQL based database which may be used as the primary persistent data store. Each of the backtest trials executed by the backtest engine 404 may be written to all data stores at the same time to provide high availability and redundancy. In case a certain accessed data store is unavailable, the backtest engine 404 may attempt to retrieve the requested data from the next available data store.

The backtest engine 404 and the CBSF storage 406 may further connect to a scalable backtesting logging platform 408 to support the sheer amount of data produced by the backtest engine 404. The backtest engine 404 and the CBSF storage 406 may communicate with the backtesting logging platform 408 asynchronously to avoid latency in the primary software components, i.e., the backtest engine 404. The backtesting logging platform 408 may be implemented using one or more storage management technologies, engines, and/or systems, for example, the ElasticSearch, Logstash, Kibana software stack (ELK). The ElasticSearch search engine is built on top of Lucene, an indexing and search library, which provides full-text search capabilities and therefore provides rapid querying capabilities for document-oriented, indexes data and all its fields. Logging analytic dashboards are implemented Kibana and Grafana. Kibana is highly suited for searching across a large number of unstructured data elements and exploring log results similar to a web search engine. For example, Kibana may be used to search across multiple backtest trial jobs that are similar to a given result, search across specific asset classes, search across researchers and/or the like. Grafana is utilized to monitor computing resources for each backtest trial job, for example, Central Processing Unit (CPU) utilization, Memory utilization, Input/Output (I/O) utilization and/or the like. Historical analysis via Grafana may be used to determine whether the distributed computing system 402 requires additional computing resources and may thus need to be expanded. The backtest engine 404 under the CBSF framework may log all parameters specific to each backtest trial job, including, for example, execution progress tracking, the UTID, the user/researcher 306 who initiated the job, the name of the investment mandate, the start and finish timestamp, the type of data accessed, the reported results and/or the like. Access to the data available in the backtesting logging platform 408 is strictly controlled by role-based and user-based entitlements to prohibit manipulation of backtesting trials.

The distributed computing system 402 may further perform as an FP estimation system such as the FP estimation system 302 and execute an FP estimator such as the FP estimator 320.

The CBSF framework may further define one or more services to support the distributed computing system 402 and the backtest engine 404, for example, for transferring investment strategies statistical models, submitting backtesting trial jobs (simulations), enable one or more of the users 306 to communicate and interact with one or more components of the system 400 and/or the like. These services may be implemented using one or more the message-broker protocols and/or agents, for example, the RabbitMQ and/or the like.

One such service is a CBSF reporting service 420 which may be deployed to may queue and schedule the backtest trial jobs for the backtest engine 404 to avoid overloading computing nodes of the distributed computing system 402 which may be in the process of executing previously submitted backtest trial jobs. The CBSF reporting service 420 may further stage the backtest trial jobs to provide high processing power availability to the backtest engine 404 in case one or more sub-components of the distributed computing system 402 are restarted for maintenance. The CBSF reporting service 420 may queue and schedule the backtest trial jobs based on one or more operational parameters, for example, time of submission of the trial job, priority of the trial job and/or the like. For example, the CBSF reporting service 420 may submit at least some of the backtest trial jobs to the backtest engine 404 using weighted round-robin scheduling where the weights are based on time and/or priority. However, the backtest engine 404 may preempt other trial jobs based on priority and available compute resources. The CBSF reporting service 420 may be further used to store the data inputs, for example, investment strategies, historical financial data, investment rules and/or the like to make this data available to one or more long-running backtest trial jobs such that this input data is not lost. The CBSF reporting service 420 may be also used for logging and transferring the predicted returns computed by the backtest engine 404 for one or more of the investment strategies to a the FP estimator 320. The CBSF reporting service 420 may be also used to enable one or more of the users 306, for example, researchers to interact with the distributed computing system 402, in particular with the backtest engine 404. Using the CBSF reporting service 420, the user 306 may asynchronously and/or simultaneously submit and/or track backtest trial jobs to the backtest engine 404. As each trial job is assigned with a unique UTID, the backtest trial jobs may be tracked throughout the system 400 thus making it possible for the user 306 (e.g. a researcher) to track the entire progress of one or more of the backtest trial jobs.

Another service is a Backtest Trial Browser (BTB) service 422 which may be deployed to enable one or more of the users 306, for example, researchers to interact with the distributed computing system 402, the CBSF storage 406 and/or the backtesting logging platform 408. The BTB service 422 provides the user(s) 306 secure read-only access to data and results to allow for rapid search and querying capabilities with SBuMT analytics built-in. For example, the user 306 (e.g. a portfolio manager) use the BTB service 422 to access false positive (FP) false positive estimation computed for one or more investment strategies back tested in the distributed computing system 402, specifically false positive estimations computed in the context of SBuMT. The user 306 (e.g. the portfolio manager) may further choose to analyze the predicted outcomes, i.e., the results and/or returns of one or more trials across multiple similar mandates conducted by the same researcher. The BTB service 422 may leverage the distributed computing system 402 to generate on-demand statistics for backtest trial sets.

One or more GUI platforms, specifically web based GUI interfaces may be deployed to enable one or more of the users 306 using client terminals such as the client terminal 304 to communicate and interact with one or more components of the system 400. In particular, the GUI interfaces may interact with the services deployed to access the components of the system 400, for example, the CBSF service 420, the BTB service 422 and/or the like. The web based GUI interfaces may communicate with the services using one or more of the message-broker protocols and/or agents, for example, the RabbitMQ and/or the like. The GUI interface may be implemented, designed and/or constructed using one or more implementations, programming frameworks, programming languages and/or the like. For example, the web based CBSF GUI interfaces may be implemented using the EmberJS web framework which provides pre-built components for displaying charts and displaying data into table formats.

For example, a CBSF GUI interface 430 may be used by one or more of the users 306 for communicating with the CBSF service 420 to access one or more components of the system 400, specifically the backtest engine 404. Via the CBSF GUI interface 430 the user 306, for example, a researcher may track the entire progress of one or more trial jobs submitted to the system 402. For example, every successful backtest trial job may return results (predicted returns and outcomes) from the CBSF service 420 to the CBSF GUI interface 430 via an Application Programming Interface (API) with at least a minimal set of parameters optionally arranged in time series, for example, Daily Assets under Management (AUM), Mark to Market values, Returns, Profit and loss (PnL), capital in/out flows, daily positions and/or the like. Moreover, each backtest trial must also return the UTID of associated benchmark to the CBSF GUI interface 430. In another example, the CBSF GUI interface 430 may be used by one or more of the users 306 (e.g. a researcher) to upload one or more statistical models, investment strategies, investment rules and/or the like via the CBSF service 420. Moreover, using the CBSF GUI interface 430, the user(s) 306 may acknowledge and/or validate one or more inputs submitted via the CBSF service 420.

In another example, a BTB GUI interface 432 may be used by one or more of the users 306 for communicating with the BTB service 430 to access one or more components of the system 400, for example, the false positive estimator 320, the backtest engine 404, the CBSF storage 406 and/or the backtesting logging platform 408.

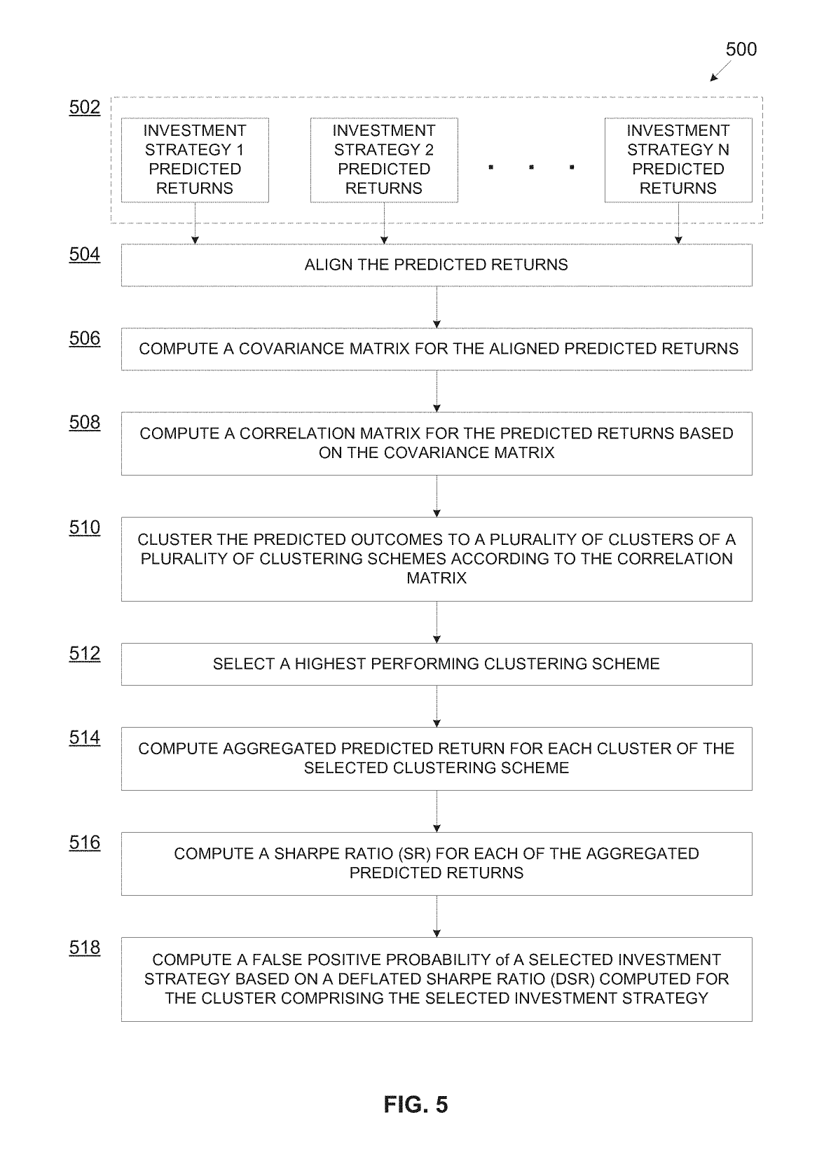

Reference is now made to FIG. 5, which is a flowchart of an exemplary process of estimating a false positive probability of an investment strategy statistical model selected from a plurality of investment strategies based on clustering of the plurality of investment strategies, according to some embodiments of the present invention. An exemplary process 500 may be executed by an FP estimator such as the FP estimator 320 executed in a system such as the system 400, in particular by the distributed computing system 402.

The process 500 is a demonstration of the process 100 adapted for estimating the false positive probability of an investment strategy statistical model selected from a plurality of statistical models trained using a limited dataset, in particular, the limited historical dataset comprising the plurality of past financial observations. The process 500 is based in part on a Deflated Sharpe Ratio (DSR) computed for the cluster comprising the selected investment strategy after clustering the plurality of investment strategies to the plurality of k clusters in the selected clustering scheme. The DSR is designed to assess the probability that the performance presented by the selected investment strategy backtest trial is reliable given the number of backtest trials (investment strategy simulations) that were performed to obtain that performance and hence indicate the false positive probability of the selected investment strategy.

As shown at 502 which corresponds to step 102 of the process 100, the process 500 starts with the FP estimator 320 receiving a plurality of N predicted returns (predicted outcomes) computed during a plurality of N backtest trials (investment strategies statistical models simulations) for the historical dataset comprising the plurality of past financial observations. The predicted returns may be computed by a backtest engine such as the backtest engine 404 executing a plurality of backtest trials simulating a plurality of investment strategies. The predicted returns typically include a series of partial predicted returns ordered according to one or more ordering schemes, specifically time ordering. As such each series of partial predicted returns may be a time series ordering the partial predicted returns according to their time stamps along a historical past time flow.

As shown at 504, the FP estimator 320 may align the predicted returns as described in step 104 of the process 100.

Applying the pairwise alignment, the FP estimator 320 may compute and evaluate

$$( \begin{matrix}N \\ 2\end{matrix} )$$

covariances between each pair of predicted returns computed in by a respective pair of the backtest trials corresponding to a respective pair of investment strategies of the N investment strategies. The FP estimator 320 may further compute N variances for each of the N predicted returns computed during the N backtest trials (investment strategies simulations). The FP estimator 320 may then aggregate the results to form the aggregated covariance matrix C for the N predicted returns computed in the N backtest trials. In particular, this computation may be executed by the FP estimator 320 in parallel on the distributed computing system 402 due to the independent nature of the computation.

Applying the multi-variate alignment, the FP estimator 320 may align the series of partial predicted returns of the plurality of predicted returns by re-indexed all these series as described in step 104 of the process 100. Pseudocode Snippet 1 below presents an exemplary Python implementation of this multi-variate series alignment step.

### Pseudocode Snippet 1:

def AlignReturns( ret ):

StartDt = [ ret[c].first_valid_index( ) for c in ret.columns ]
EndDt = [ ret[c].last_valid_index( ) for c in ret.columns ]
StartDt = pd.Series( StartDt, index = ret.columns ).min( )
EndDt = pd.Series( EndDt, index = ret.columns ).max( )
ret = ret[ (ret.index>=StartDt)&(ret.index<=EndDt)]
# Set to index with median frequency
# In case of two columns, sets to lowest frequency
BarQuartile = 0.5
ColWithIdx=ret.count( ).sort_values( ).index[int(BarQuartile*(len(ret.columns)−1))]
idx = ret[ColWithIdx].dropna( ).index
return (1.+ret.fillna(0.)).cumprod( ).reindex(idx).pct_change( ).dropna( )

As shown at 506, after aligned, the FP estimator 320 may compute the aggregated covariance matrix C for the N predicted returns computed during the N investment strategies simulations, i.e., the N backtest trials as describe in step 104 of the process 100. Moreover, as describe in step 104 of the process 100, after computing the aggregated covariance matrix C, in case it is required, the FP estimator 320 may perform one or more post-processing operations to adjust the aggregated covariance matrix C to ensure it is positive definite. Pseudocode Snippet 2 below presents an exemplary Python implementation for evaluating the aggregated covariance matrix C.

### Pseudocode Snippet 2:

def GetCovariance(i,j,returns):

return AlignReturns( returns[[i,j]] ).cov( ).iloc[0,1]

def work(job):

try:

return GetCovariance(job[0],job[1],job[2])

except:

return 0.

def cov2corr(cov):

sigma = np.sqrt(np.diag(cov))
return cov / np.outer(sigma, sigma)

def MakeCorrMatrix( returns, shrinkage=False, epsilon=None ):

jobs=[ (returns.columns[i],returns.columns[j],returns) for i in

range(len(returns.columns))\ for j in range(i+1,len(returns.columns) ]

cov = pd.DataFrame(0. , index = returns.columns, columns=returns.columns)
t0 = time.time( )
for col in returns.columns:

cov.loc[col,col] = returns [col].dropna( ).var( )

for job in jobs:

cov.loc[job[0],job[1]] = work(job)
cov.loc[job]1],job[0]] = cov.loc[job[0],job[1]]

cov = cov.fillna(0.)
print ‘Runtime for covariance calculation:’ , time.time( ) − t0, ‘seconds’
# Check eigenvalues to ensure positive definiteness
eigValues = np.sort( np.linalg.eig(cov)]0] )
minEig = eigValues[0]
# Shift up the eigenvalues to make cov positive definite if smallest eigenvalue is
negative
if minEig < 0:

if epsilon == None:

epsilon = 0.1 * np.abs(minEig)

shift = minEig − epsilon
cov −= shift * np.identity(cov.shape[0])

if shrinkage:

from sklearn.covariance import LedoitWolf
lw = LedoitWolf( )
lw = lw.fit( cov )
cov=pd.DataFrame(lw.covariance_,index=cov.columns, columns=cov.columns)
# Make covariance matrix from correlation matrix
corr = cov2corr( cov )
corr[ corr > 1 ] = 1. # fix machine precision issues
return corr

As shown at 508, the FP estimator 320 may compute the correlation matrix as described in step 104 of the process 100 based on the aggregated covariance matrix C and/or the adjusted aggregated covariance matrix C in case such adjustment was applied.

As shown at 510 which correspond to step 106 of the process 100, the FP estimator 320 may cluster the plurality of N predicted returns into a plurality of k clusters based on the computed correlation matrix. Moreover, to identify the most effective clustering scheme, the FP estimator 320 may cluster the N predicted returns to k clusters in each of a plurality of clustering schemes each defining a different number k of clusters where k=2, 3, 4, . . . K where K<N. Clustering the predicted returns may be regarded as clustering the backtest trials and hence as clustering the investment strategies.

The FP estimator 320 may cluster the N predicted returns according to the distance matrix computed for the predicted returns as described in step 106 of the process 100. Pseudocode Snippet 3 below presents an exemplary Python implementation for clustering the N predicted returns.

### Pseudocode Snippet 3:

def clusterSCC(corr0,maxNumClusters=10):

#http://scikit-learn.org/stable/auto_examples/cluster/plot_kmeans_silhouette_analysis.html
from sklearn.cluster.bicluster import SpectralCoclustering
from sklearn.metrics import silhouette_samples
dist,silh=((1−corr0.fillna(0))/2.)**.5,pd.Series( ) # distance matrix
for i in xrange(2,maxNumClusters+1): # find optimal num clusters

scc_=SpectralCoclustering(n_clusters=i,n_jobs=−1)
scc_=scc_.fit(corr0)
silh_=silhouette_samples(dist,scc_.row_labels_,metric=‘precomputed’)
stat=(silh_.mean( )/silh_.std( ),silh.mean( )/silh.std( ))
print i,stat
if np.isnan(stat[1]) or stat[0]>stat[1]:

silh,scc=silh_,scc_{—}

corr1=corr0.iloc[np.argsort]scc.row_labels_)] # reorder rows
corr1=corr1.iloc[:,np.argsort]scc.column_labels_)] # reorder columns
if not (corr1.columns==corr1.index).all( ):

raise Exception(‘Sequence of rows does not match sequence of columns’)

clstrs={i:corr0.columns[scc.get_indices(i)[0]].tolist( ) for i \

in xrange(scc.get_params( )[‘n_clusters’])} # cluster members

silh=pd.Series(silh,index=dist.index)
return corr1,clstrs,silh

A shown at 512, the FP estimator 320 may select the clustering scheme with the highest quality score as described in step 108 of the process 100.

A shown at 514, the FP estimator 320 may compute an aggregated predicted return for each cluster of the K clusters of the elected clustering scheme as described in step 110 of the process 100. The FP estimator 320 compute the aggregated predicted return of each cluster by aggregating the predicted returns computed clustered in the respective cluster. For example, the aggregated predicted return of cluster 1 may be computed by aggregating all the predicted returns clustered in cluster 1.

Since each of the predicted returns computed in the plurality of backtest trials of the investment strategies may include a series of predicted partial returns, the aggregated predicted return computed by the FP estimator 320 for each of the K clusters is also a series, specifically a time series of aggregated predicted partial returns. In order to compute the aggregated predicted return for each cluster of the K clusters, the FP estimator 320 may first align the time series of partial predicted returns of all predicted returns clustered in the respective cluster in order to be able to properly and accurately aggregate these time series. The FP estimator 320 may align the time series in each of the clusters by applying the pairwise alignment and/or the multi-variant alignment as described in step 504 and step 104 of the process 100. Repeating the alignment for the k=1, . . . , K clusters may thus result in K aggregated returns time series {r_{k,t}} which is set to the average of the Nₖ series that are now aligned.

The result of the aggregation done by the FP estimator 320 may therefore include K aggregate predicted return time series. The dimensionality of the space is thus reduced from N to K.

As shown at 516, the FP estimator 320 may compute an estimated non-annualized Sharpe ratio (SR) for each of the K aggregate predicted return time series {r_{k,t}}_{t=1, . . . 3} according to equation 1 below where T is the number of observations (length) of the aggregated returns time series {r_{k,t}}.

$${SR}_{k} = \frac{E [ {\{ {r}_{k , t} \}}_{t = 1 , … , T} ]}{\sqrt{V [ {\{ {r}_{k , t} \}}_{t = 1 , … , T} ]}} \qquad Equation 1$$

Where T is the length of the aggregated returns time series {r_{k,t}} of the cluster k.

As shown at 518, the FP estimator 320 may compute the false positive probability (PSR) of an investment strategy selected from the plurality of N investment strategies by computing the Deflated Sharpe Ratio (DSR) of the cluster comprising the selected investment strategy, i.e., the cluster to which the selected investment strategy is clustered. Applying the DSR may ensure that the SR is statistically significant by controlling for the inflationary and biasing effect of multiple trials, outliers, data dredging, non-normal returns and shorter historical training dataset lengths.

The FP estimator 320 may first compute variance across the plurality of K clusters of the selected clustering scheme, specifically across the aggregate predicted returns of the K clusters. The FP estimator 320 computes an estimated variance E[V[{SRₖ}]] for each cluster k=1, . . . , K. The estimated variance may be computed based on an annualized Sharpe ratio (aSR) which may be derived from the aggregated predicted return time series computed for each cluster k as formulated in equation 2 below.

$${aSR}_{k} = \frac{E [ {\{ {r}_{k , t} \}}_{t = 1 , … , T} ] {Frequency}_{k}}{\sqrt{V [ {\{ {r}_{k , t} \}}_{t = 1 , … , T} ]} {Frequency}_{k}} = {SR}_{k} \sqrt{{Frequency}_{k}} \qquad Equation 2$$

Where Frequencyₖ is computed as the number of observations T in the aggregated returns time series {r_{k,t}} of cluster k divided by the total number of years for which the investment strategies are simulated.

The FP estimator 320 may compute the estimated variance of each cluster k according to equation 3 below.

$$E [ V [ \{ {SR}_{k} \} ] ] = \frac{V [ \{ {aSR}_{k} \} ]}{{Frequency}_{k} } \qquad Equation 3$$

Using the estimated variance, the FP estimator 320 may compute the maximum SR for each of the cluster k=1, . . . , K as expressed in equation 4 below.

$${SR}_{max}^{K} = \sqrt{V [ \{ {SR}_{k} \} ]} ( ( 1 - γ ) {Z}^{- 1} [ 1 - \frac{1}{K} ] + γ {Z}^{- 1} [ 1 - \frac{1}{{K}_{e}} ] ) \qquad Equation 4$$

Where Z⁻¹ [.] is the inverse of the Cumulative Distribution Function (CDF) of the standard normal distribution, K is the number of clusters, i.e., the number of independent investment strategies, e≈2.718 is Euler's number, and γ≈0.577 is the Euler-Mascheroni constant.

The FP estimator 320 may compute the false positive probability (PSR) of the cluster k to which the selected investment strategy is clustered according to equation 5 below.

$$PSR [ {SR}_{k} , {SR}_{max}^{K} ] = Z [ \frac{( {SR}_{k} - {SR}_{max}^{K} ) \sqrt{T - 1}}{\sqrt{1 - {γ}_{3} {SR}_{k} + \frac{{γ}_{4} - 1}{4} {SR}_{k}^{2}}} ] \qquad Equation 5$$

Where Z[.] is the CDF of the standard normal distribution, SRₖ is the estimated SR computed for cluster k, T is the number of observations, γ₃ is the skewness of the predicted returns, and γ₄ is the kurtosis of the predicted returns.

In conclusion, DSR may indicate the likelihood that the selected investment strategy is a true positive, in the sense that the strategy is required to perform significantly better than what would be expected out of sheer luck through the multiple backtesting trials as expressed by SRₘₐₓ^{K}. The DSR may estimate the statistical “confidence” that the investment strategy is not a false discovery, defined as the probability complementary to the false positive (Type I Error) probability. Pseudocode Snippet 4 below presents an exemplary Python implementation for the DSR computation.

### Pseudocode Snippet 4:

def MakeClusterAvgReturns( returns ):

return AlignReturns( returns ).mean(axis=1)

def getExpMaxSR(mu,sigma,numTrials):

# Compute the expected maximum Sharpe ratio (Analytically)
emc=0.5772156649 # Euler-Mascheroni constant
maxZ=(1−emc)*ss.norm.ppf(1−1./numTrials)+emc*ss.norm.ppf(1−1/(numTrials*np.e))
return mu+sigma*maxZ

def DSR(returns):

numTrials = returns,shape[1]
StartDt = pd.Series( [ returns[c].first_valid_index( ) for c in returns.columns ], \

index = returns.columns )

EndDt = pd.Series( [ returns[c].last_valid_index( ) for c in returns.columns ], \

index = returns.columns )

yrs = (EndDt − StartDt) / np.timedelta64(1,‘D’) / 365.25
freq = returns.count( ) / yrs
aSR = returns.mean( ) / returns. std( ) * freq**.5
aSR_sigma = aSR.std( )
# Get the sigma per bar for each cluster
# sigma * sqrt( freq ) = aSR_sigma =>
sigma = aSR_sigma / freq**.5
SR_max = getExpMaxSR(0, sigma, numTrials)
SR_hat = returns.mean( ) / returns.std( )
T = returns.count( )
gamma3 = returns.skew( )
gamma4 = 3. + returns.kurtosis( )
term = (SR_hat−SR_max)*np.sqrt(T−1) / np.sqrt(1. − gamma3*SR_hat + (gamma4 − 1.)/4. *\

SR_hat*SR_hat )

return pd.Series( ss.norm.cdf( term ) , index=returns.columns )

The FP estimator 320 may output, transmit, deliver and/or provide the false positive probability estimated for the selected statistical model to one or more of the users 306 which may use the estimated false positive probability to assess whether and how to employ the selected statistical model.

Following is an example for demonstrating the process 500 for an exemplary long-short investment strategy on high grade corporate bonds selected from 6,385 backtest trials conducted by a backtest engine such as the backtest engine 404 to simulate a plurality of investment strategies. Table 2 below presents performance statistics of an exemplary long-short investment strategy on high grade corporate bonds designated as a first investment strategy herein after.

TABLE 2

| Start Date | 2010 Jan. 21 |
|---|---|
| End Date | 2018 May 01 |
| aRoR (Total) | 9.35% |
| Average AUM (1E6) | 1506.43 |
| Average Gini | 0.88 |
| Average Duration | 0.08 |
| Average Default Probability | 1.58% |
| Annualized Sharpe Ratio (SR) | 2.00 |
| Turnover | 5.68 |
| Efficient Number | 186.26 |
| Correlation to Ix | 0.48 |
| Drawdown (95%) | 2.89% |
| Time Underwater (95%) | 0.20 |
| Leverage | 3.59 |

As can be seen from table 2, the annualized SR of the first investment strategy is 2.00 with an annualized return of 9.35% and an average duration of only 0.08. The 95-percentile of the drawdowns is only 2.89%, and the 95-percentile of the time underwater is only 0.2 years.

This selected investment strategy may be considered a good performing investment strategy by most investment professionals. However, the SBuMT affects are not reflected in the performance statistics and which may be therefore highly misleading.

The process 500 may be therefore applied to the plurality of backtest trails to estimate whether the selected investment strategy is false positive, i.e., to compute a false positive probability of the selected investment strategy.

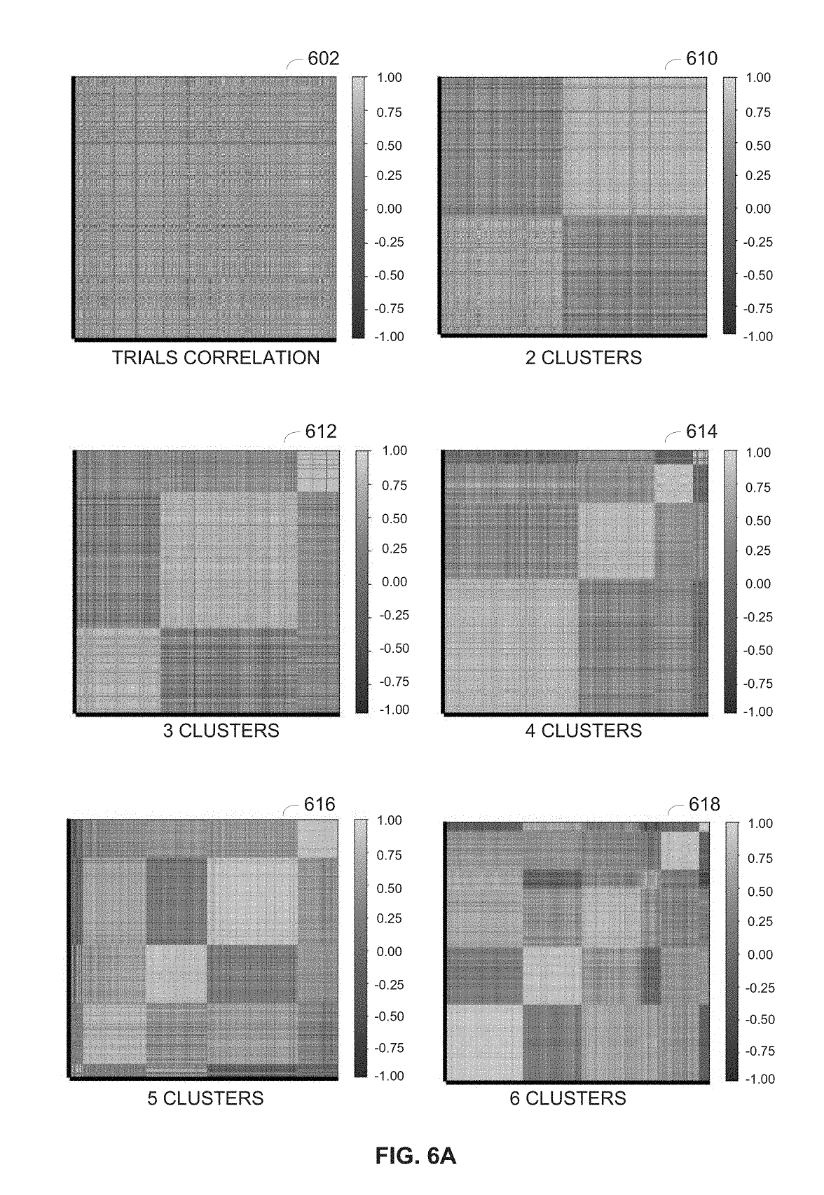

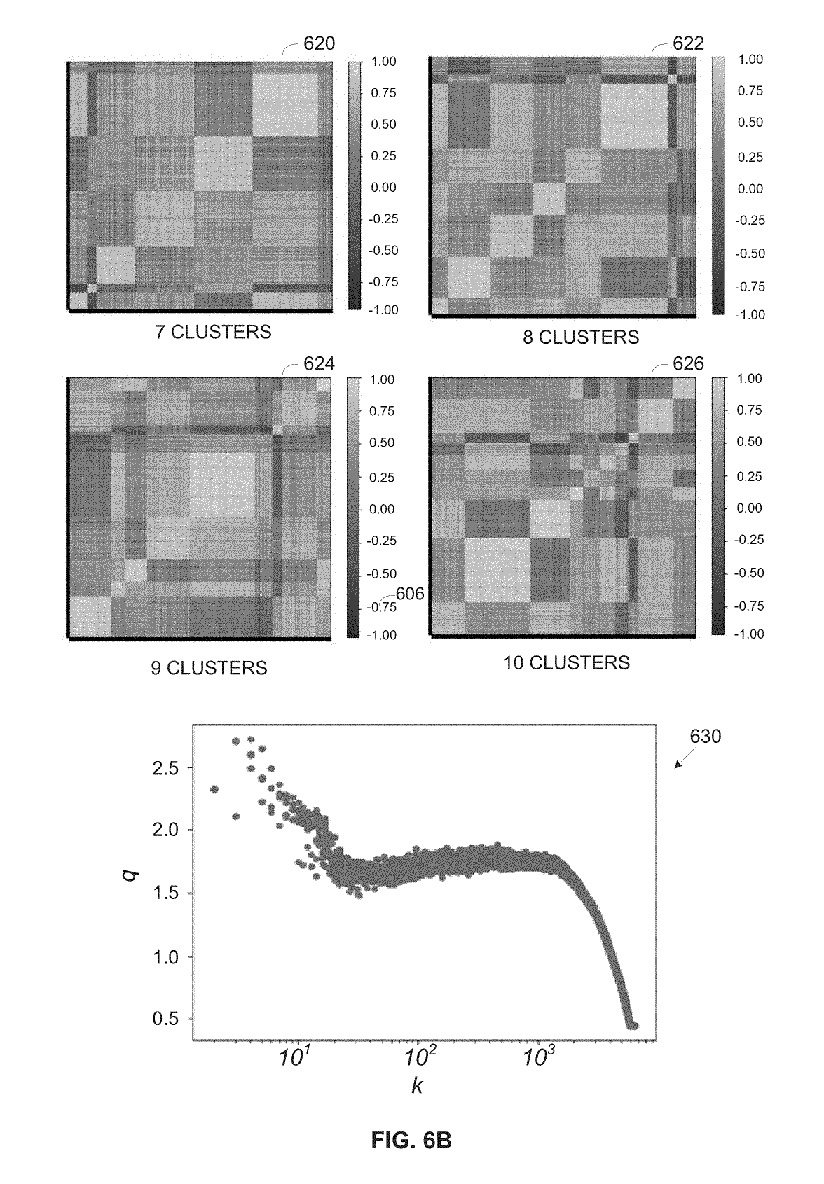

Reference is now made to FIG. 6A and FIG. 6B which present exemplary clustering schemes for clustering backtest trials simulating a plurality of investment strategies fitted on historical financial data to support estimation of a false positive probability of a selected investment strategy, according to some embodiments of the present invention. FIG. 6A and FIG. 6B present heat-maps 602, 610, 612, 614, 616, 618, 620, 622, 624 and 626 which visually express the correlation between the predicted returns computed in the 6,385 backtest trials from which the selected exemplary investment strategy is selected. In particular, the heat-maps visually present the several clustering schemes applied to cluster the 6,385 backtest trials.

After an FP estimator such as the FP estimator 320 executing a process such as the process 500 computes a correlation matrix for the 6,385 backtest trials conducted by the backtest engine 404, the correlation between the 6,385 backtest trials may be expressed by the heat-map 602.

The FP estimator 320 may then apply a plurality of clustering schemes to cluster the backtest trials as described in step 510 of the process 500. The heat-map 610 presents the 6,385 backtest trials clustered to two clusters, the heat-map 612 presents clustering to three clusters, the heat-map 614 presents clustering to four clusters, the heat-map 616 presents clustering to five clusters, the heat-map 618 presents clustering to six clusters, the heat-map 620 presents clustering to seven clusters, the heat-map 622 presents clustering to eight clusters, the heat-map 624 presents clustering to nine clusters and the heat-map 626 presents clustering to ten clusters.

The FP estimator 320 may then compute the quality score for each of the clustering schemes as described in step 512 of the process 500 and the step 108 of the process 100. The computed quality scores may yield the following results: 2.3274 for the two clusters scheme, 2.7068 for the three clusters scheme, 2.7281 for the four clusters scheme, 2.6517 for the five clusters scheme, 2.4919 for the six clusters scheme, 2.3605 for the seven clusters scheme, 2.2822 for the eight clusters scheme, 2.2594 for the nine clusters scheme and 2.2211 for the ten clusters scheme. As seen, the four clusters clustering scheme presents the highest quality score and evidently the quality score constantly decreases for clustering schemes defining larger numbers of clusters.

A graph plot 630 as seen in FIG. 6B presents the distribution of quality scores for a plurality (2 to 6,384) of clustering schemes applied for clustering the 6,385 backtest trials where the X axis presents (in polynomial scale) the number of clusters and the Y axis presents the quality score. As evident form the graph plot 630, the observation made before based on the computed first nine clustering schemes the maximum quality is achieved for four clusters with the clustering quality decaying abruptly after ten clusters.

The FP estimator 320 may therefore select the four clusters clustering scheme which corresponds to four substantially uncorrelated backtest trials among the 6,385 backtest trials simulated by the backtest engine 404.

As described in step 514 of the process 500, the FP estimator 320 may compute an aggregated predicted return for each of the four clusters and may further associate them with the expected maximum Sharpe ratio as described in step 518 of the process 500.

The FP estimator 320 may compute performance statistics for the aggregated predicted returns which may prevent outlier backtest trials from significantly biasing the results. These compute performance statics are presented in Table 3 below.

TABLE 3

| Statistics | Cluster 0 | Cluster 1 | Cluster 2 | Cluster 3 |
|---|---|---|---|---|
| Start Date | 2010 Jan. 04 | 2010 Jan. 04 | 2010 Jan. 04 | 2010 Jan. 04 |
| End Date | 2018 May 01 | 2018 Apr. 25 | 2018 May 03 | 2018 May 21 |
| Backtest Trials | 3265 | 1843 | 930 | 347 |
| aSR | 1.5733 | 1.4907 | 2.0275 | 1.0158 |
| SR | 0.0974 | 0.0923 | 0.1255 | 0.0629 |
| Skewness | −0.3333 | −0.4520 | −0.4194 | 0.8058 |
| Kurtosis | 11.2773 | 6.0953 | 7.4035 | 14.2807 |
| T | 2172 | 2168 | 2174 | 2172 |
| Frequency | 261.0474 | 261.0821 | 261.1159 | 261.0474 |
| V [{SRₖ}] | 0.0257 | 0.0256 | 0.0256 | 0.0257 |
| E [SRₘₐₓ^{k}] | 0.0270 | 0.0270 | 0.0270 | 0.0270 |
| DSR | 0.9993 | 0.9985 | 1.000 | 0.9558 |

The selected investment strategy (documented in table 2) is clustered into cluster 2 which contains 930 trials. The non-annualized SR computed by the FP estimator 320 for aggregated predicted return on cluster 2 is 0.1255.

For the four clusters with 0.0256 standard deviation across the clusters SRs the “False Strategy” theorem expects E[SRₘₐₓ^{K}] of 0.027, taking into account the number of clusters, their skewness and kurtosis, as described in step 518 of the process 500, the probability computed by the FP estimator 320 that the SR of the selected investment strategy is significantly greater than the E[SRₘₐₓ^{K}] and hence the probability that the selected investment strategy is false positive is practically zero.

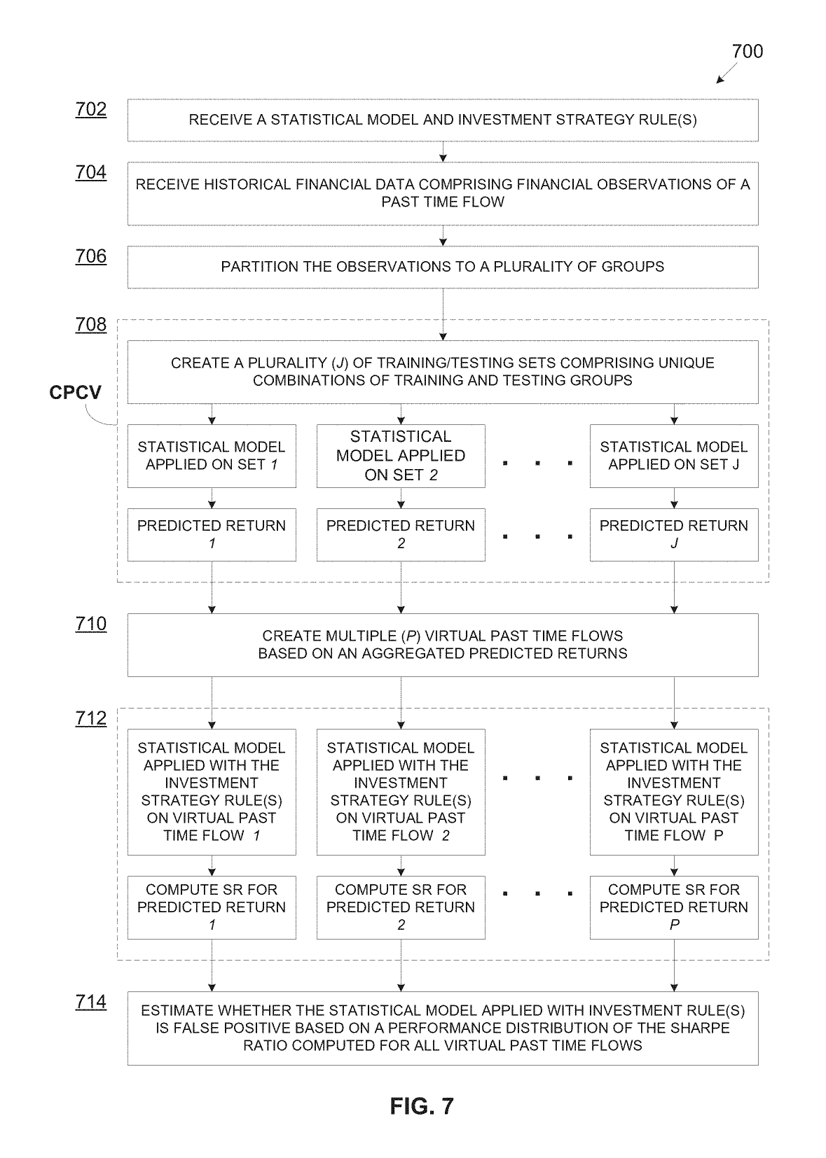

Reference is now made to FIG. 7, which is a flowchart of an exemplary process of estimating a false positive probability of an investment strategy statistical model based on distribution of performance computed for a plurality of virtual time flows, according to some embodiments of the present invention. An exemplary process 700 may be executed by an FP estimator such as the FP estimator 320 executed in a system such as the system 400, in particular by the distributed computing system 402.

The process 700 is a demonstration of the process 200 adapted for estimating the false positive probability of a selected investment strategy trained and tested using a limited dataset, in particular, the limited historical dataset comprising the plurality of past financial observations of one or more financial markets, for example, the stock exchange, the commodities exchange, the currency rates, trading trends and conditions, state and government financial data and/or the like.

As shown at 702, the process 700 starts with the FP estimator 320 receiving a statistical model M and one or more rule R which reflect an investment strategy to be evaluated when applied on the statistical model M.

As shown at 704 which corresponds to step 202 of the process 200, the process 700 starts with the FP estimator 320 receiving the historical dataset comprising the plurality of past observations ordered along a (historical) past time flow. In particular, the historical dataset comprises the plurality of past financial observations. The past financial observations are ordered in a time series and are not shuffled.

As shown at 706 which corresponds to step 204 of the process 200, the FP estimator 320 may partition the plurality of past observations to a plurality of groups such that each group comprises a respective subset of the plurality of past observations documenting a segment of the past time flow. Moreover, since the groups may be used for training and testing a statistical model, in order to prevent data leakage between groups the FP estimator 320 may create the groups such that each observation may be included in only a single group and the subset of observations in each group comprises subsequent observation along the past time flow. As such none of the groups may overlap in time with any other group and the groups are hence purged from mutual information.

Assuming there are T past observations which are partitioned by the FP estimator 320 into N<T groups without shuffling. Let T=cN+d, where c and d are non-negative integers and d<N. The groups n=1, . . . , d are therefore of size └T/N┘+1=c+1, where └·┘ is the floor function, and groups n=d+1, . . . , N are of size └T/N┘=c. In other words, the N groups are disjoint and each group is of essentially the same size.

Optionally, the FP estimator 320 further enhances the purging of the groups of the testing set from mutual information with groups of the training set by inserting a predefined time margin (“embargo”) between the respective subsets of observations of the groups included in the training set and the observations of group included in the testing set. As such, observations which are identified in the predefined time margin are dropped from the training set.

The purging of the groups used for the training sets and the testing sets of the combinatorial train-test sets may be demonstrated by the following example. Assuming the statistical model is a classifier applied to classify a label of 1 or −1 used to indicate if the market is going up or down, respectively. If the label for a given observation (data point) at, say 9 AM is crafted by observing the price went up 1% by 4 PM the same day, then it would be inappropriate to include that observation in the training set for a model fitting at 3 PM. Otherwise that would be incorporating “future information”, impacting the classifier result at 3 PM with information from 4 PM. Therefore, the FP estimator 320 must incorporate a time series t₁ whose index is the same as the indexes of the historical dataset (in our example, 9 AM), and whose values are the timestamps at which point the label is known (in our example 4 PM). Given a testing set observation with timestamp t₀=3 PM, the FP estimator 320 must only include in the training set observations where t₁≤t₀ for all timestamps t₀ in the respective testing set. Furthermore, let T₁=max t₁ of the observations in the testing dataset. Thus, the FP estimator 320 may include in the respective training set all observations from the historical dataset having timestamps t₀, where T₁<t₀.

As described herein before, the FP estimator 320 may further enhance the purging of the groups by inserting a predefined time margin (“embargo”) between the respective subsets of observations of the groups included in the training set and the observations of group included in the testing set. To continue the previous example, the FP estimator 320 may a predefined time margin “embargo”) period t₂≥0 so that T₁=t₂+max t₁ of the observations in the testing dataset.

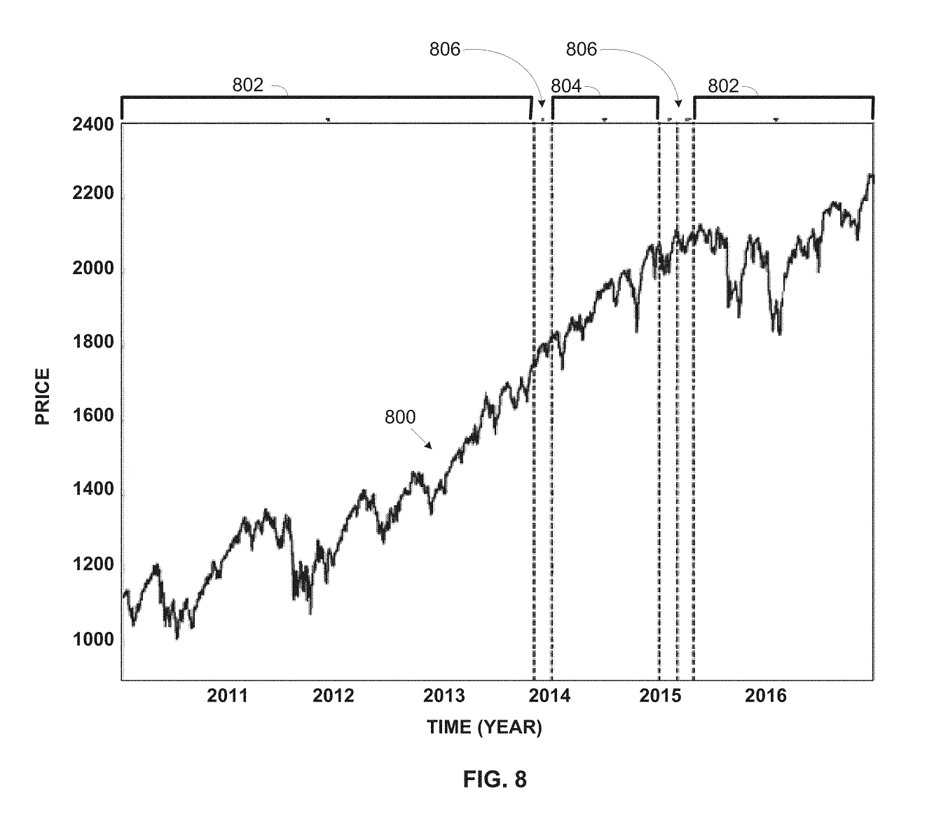

Reference is now made to FIG. 8, which is a graph chart of a plurality of observations of an equity price along a past time flow which are partitioned to groups, according to some embodiments of the present invention. A graph 800 represents a price of a certain equity as observed over a certain time period, for example, between the years 2010 and 2018. As seen a certain one of the combinatorial train-test sets created by the FP estimator 320 includes a training set 802 comprising a plurality of groups each comprising a plurality of price observations of the equity. The certain combinatorial train-test set also include a testing set 804 comprising other groups containing price observations which are not included in the groups of the training set 802. As evident the training set 802 and the testing set 804 do not overlap such that none of the price observations may be included in both the training set 802 and the testing set 804. Moreover, the FP estimator 320 may apply a predefined time margin (“embargo”) 806 between the training set 802 and the testing set 804 such that observations identified in the predefined time margin (period) 806 are dropped and are thus not included in the training set 802 and not in the testing set 804.

Referring once again to FIG. 7.

As shown at 708 which is the CPCV process, the FP estimator 320 may create a plurality of combinatorial train-test sets. Each of the combinatorial train-test sets includes the plurality of groups arranged in a unique training-testing split between testing groups and training groups. As such, the FP estimator 320 constructs the combinatorial train-test sets to include a testing set which comprises one or more of the groups and a training set which includes all the other groups which are not included in the testing set.

Assuming the testing set of each of the combinatorial train-test sets includes k of the N groups, the number of unique combinations of possible training set/testing set splits is

$$( \begin{matrix}N \\ k\end{matrix} ) = J ,$$

or the binomial coefficient “N choose k”. Each combinatorial train-test set is made up of k groups, thus giving a total of k

$$( \begin{matrix}N \\ k\end{matrix} )$$

distinct groups in the combinatorial train-test set. Each group n (n=1, . . . , N) is represented an equal number of times across the plurality of combinatorial train-test sets.

As the FP estimator 320 originally constructed the groups include different subsets of the observations, the testing set of each of the combinatorial train-test sets is purged from mutual information and data leakage to the training set of the respective combinatorial train-test set.

The FP estimator 320 may then receive a plurality of predicted returns (results) computed by the evaluated statistical model M simulated using the plurality of combinatorial train-test sets. Each of the predicted returns is computed by training (fitting) the statistical model M using the training set of a respective one the plurality of combinatorial train-test sets and applying the trained evaluated statistical model on the testing set of the respective combinatorial train-test set.

For example, assuming the historical dataset includes a time series dataset X indexed by an increasing time series, and a set of classification labels Y, for example with values +1 or −1 depending on whether the price series is increasing or decreasing, respectively, with the same time index as X. A time series t₁, similarly indexed, with values indicating the timestamp through which each observation (label) in Y is constructed. The plurality of past financial observations is constructed by associating the indexed data points from dataset X with the indexed data points from dataset Y according to their time stamps. The statistical model M therefore trains on an input training set Xₜᵣₐᵢₙ from the dataset X, and is trained to approximate the corresponding Yₜᵣₐᵢₙ from Y. Since J distinct combinatorial train-test sets are created by the FP estimator 320, the statistical model M may be trained to compute a predicted return (result) M^{j} using Xₜᵣₐᵢₙ^{j} and Yₜᵣₐᵢₙ^{j}. For a given input Xₜₑₛₜ from the dataset X, the statistical model M may compute a predicted output M(Xₜₑₛₜ)=Ŷ, where Ŷ which are predicted values for the labels. The statistical model M may create a plurality of predicted outputs Xₜᵣₐᵢₙ^{j}, Yₜᵣₐᵢₙ^{j}, Xₜₑₛₜ^{j}, and Yₜₑₛₜ^{j} for j=1, . . . , J.

Due to the independence of the computation of the statistical model M for each of the simulations M^{j} using Xₜᵣₐᵢₙ^{j} and Yₜᵣₐᵢₙ^{j}, these simulations may be processed in parallel by a backtest engine such as the backtest engine 404.

The FP estimator may then aggregate predicted returns (results) M^{j} (Xₜₑₛₜ)=Ŷ_{J} for all the combinatorial train-test sets to obtain model paths P₁ through P_{ϕ}.

As shown at 710 which corresponds to step 210 of the process 200, the FP estimator 320 may create a plurality of virtual past time flows by aggregating the plurality of predicted returns.

As each of the combinatorial train-test sets includes a unique combination of the N groups which are put in time order, each combinatorial train-test set may represent a virtual past time flow (“historical path”). The FP estimator 320 may therefore create

$$\frac{k}{n} ( \begin{matrix}N \\ k\end{matrix} ) = ( \begin{matrix}N - 1 \\ k - 1\end{matrix} ) = φ [ N , k ]$$

total virtual past time flows made up exclusively of data (past observations) tested out-of-sample thus applying Combinatorial Purged Cross Validation (CPCV) training of the evaluated statistical model. Notably, each virtual past time flow is trained on a portion

$$θ = 1 - \frac{k}{N}$$

of me data.

A simple example is presented herein to demonstrate creation of the virtual past time flows. Assuming the past observations are partitioned into N=6 groups and the testing set in each of the combinatorial train-test sets is set to include k=2 groups. This results in the number combinatorial train-test sets equal to

$$( \begin{matrix}N \\ k\end{matrix} ) = J = 15 ,$$

and the number of virtual past time flows ϕ[N,k]=5.

Let G1 denote Group 1, G2 denote Group 2, and so on through Group 6. Similarly, let S1 denote simulation 1 executed using combinatorial train-test set 1, S2 denote simulation 2 executed using combinatorial train-test set 2, and so on through simulation 15 executed using combinatorial train-test set 15. Table 1 below delineates which groups are in the testing set in each simulation.

TABLE 1

| | S1 | S2 | S3 | S4 | S5 | S6 | S7 | S8 | S9 | S10 | S11 | S12 | S13 | S14 | S15 |
|---|---|---|---|---|---|---|---|---|---|---|---|---|---|---|---|
| G1 | 1 | 2 | 3 | 4 | 5 | | | | | | | | | | |
| G2 | 1 | | | | | 2 | 3 | 4 | 5 | | | | | | |
| G3 | | 1 | | | | 2 | | | | 3 | 4 | 5 | | | |
| G4 | | | 1 | | | | 2 | | | 3 | | | 4 | 5 | |
| G5 | | | | 1 | | | | 2 | | | 3 | | 4 | | 5 |
| G6 | | | | | 1 | | | | 2 | | | 3 | | 4 | 5 |

As can be seen from Table 1, G1 is a testing set in simulations S1, S2, S3, S4, and S5 for a total of 5 simulations. Similarly, G2 is a testing set in simulations S1, S6, S7, S8, and S9, again for a total of 5 simulations. In general, each group is in the testing set for ϕ[N,k]=5 simulations, and thus the FP estimator 320 may artificially create 5 distinct virtual past time flows (historical paths).

Notice that there is a natural construction for these ϕ virtual past time flows from the simulation ordering. For example, the 2nd simulation to test G1 is in simulation S2, the 2nd simulation to test G2 is in simulation S6, and so on for each group through G6. The FP estimator 320 may concatenate together the predicted outcomes computed by the evaluated statistical model testing these groups across simulations may be to make model path P₂. In general, the l^{th} model path P₁ may be constructed by concatenating together the predicted outcomes computed for the l^{th} simulation in which each group is tested for l=1, . . . , ϕ.

As shown at 712, the FP estimator 320 may compute the performance of the evaluated statistical model M applied with one or more investment rule R based on the performance of the predicted returns computed by the evaluated statistical model M applied with the investment rule(s) R for each of the virtual past time flows. The FP estimator 320 may apply the evaluated statistical model with the rule R=R (P) on each of the generated model paths Pᵢ such that the evaluated statistical model computes the predicted returns for the investment rule Rᵢ=R(Pᵢ) for i=1, . . . , ϕ along each model path Pᵢ given by these model outputs. The FP estimator 320 may compute the performance of each of these predicted returns using one or more standard metrics, for example, Sharpe Ratio (SR) and/or the like to obtaining SRᵢ=SR(Rᵢ) for i=ϕ,

As shown at 714, the FP estimator 320 may evaluate whether the evaluated statistical model M applied with the investment rule R is false positive by evaluating the performance distribution across all the virtual past time flows. For example, the FP estimator 320 may analyze the distribution of the SRᵢ=SR(R₃) computed for each of the model paths Pᵢ. In particular, the FP estimator 320 may derive the SR associated with the 5 percentile, hence providing a stress-test estimate of the SR under a 95% confidence level.

The FP estimator 320 may further output the predicted returns, the evaluated performance and/or the false positive indication. For example, the provided data, specifically the predicted returns may be displayed in a histogram and used to gauge the efficacy of the statistical model applied with the investment rule(s).

It should be noted that since the predicted outcomes computed by the evaluated statistical model are, by design, tested out-of-sample and trained using curated data throughout time. The distribution of the predicted outcomes may be stress tests of the investment rule R and the evaluated statistical model.

Pseudocode Snippet 5 below presents an exemplary Python implementation for the CPCV method as a class which can be used with the sklearn module.

### Pseudocode Snippet 5:

class CombinatorialPurgedKFold(_BaseKFold):

′′′
Extend PurgedKFold to work with labels that span intervals in a combinatorial setting
The train is purged of observations overlapping test-label intervals
Test set is assumed contiguous (shuffle=False), without training examples in between
′′′
def _{——}init_{——}(self,n_splits=3,k_blocks=1,t1=None,pctEmbargo=0.):

```
  import numpy as np, pandas as pd
  import itertools
  if not isinstance(t1,pd.Series):raise ValueError(‘Label Through Dates must be a pandas
```

series’)

super(CombinatorialPurgedKFold,self)._{——}init_{——}(n_splits,shuffle=False,rando

m_state=None)

```
  self.t1=t1
  self.pctEmbargo=pctEmbargo
  self.k_blocks=k_blocks
```

def split(self,X,y=None,groups=None):

if (X.index==self.t1.index).sum( )!=len(self.t1):

raise ValueError(‘X and ThruDateValues must have the same index’)

```
  indices=np.arange(X.shape[0])
  mbrg=int(X.shape[0]*self.pctEmbargo)
  block_starts=[(i[0],i[−1]+1) for i in
```

np.array_split(np.arange(X.shape[0]),self.n_splits)]

for A in itertools.combinations(block_starts,self.k_blocks):

```
  test_indices=np.concatenate( [ indices[x[0]:x[1]] for x in A ] )
  train_indices=np.copy(indices)
  for x in A:
```

```
  t0=self.t1.index[x[0]] # start of test set
  maxT1Idx=self.t1.index.searchsorted(self.t1[indices[x[0]:x[1]]].max( ))
  TrainSet=self.t1.index.searchsorted(self.t1[self.t1<=t0].index) #
```

left train

TrainSet=np.concatenate((TrainSet,indices[maxT1Idx+mbrg:])) #

add right train (with embargo)

train_indices=np.intersect1d(train_indices,TrainSet)
yield train_indices,test_indices

def GroupIndices(self,X,y=None):

if (X.index==self.t1.index).sum( )!=len(self.t1):

raise ValueError(‘X and ThruDateValues must have the same index’)

return np.array_split(np.arange(X.shape[0]),self.n_splits)

def GroupCombinations(self,X,y=None):

if (X.index==self.t1.index).sum( )!=len(self.t1):

raise ValueError(‘X and ThruDateValues must have the same index’)

return [A for A in itertools.combinations(np.arange(self.n_splits),self.k_blocks)]

It is expected that during the life of a patent maturing from this application many relevant systems, methods and computer programs will be developed and the scope of the term statistical models is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of estimating whether a statistical model selected from a plurality of statistical models trained using observed historical data is a false positive, comprising:
using at least one processor for:
receiving a plurality of predicted outcomes computed by a plurality of statistical models for a historical dataset comprising a plurality of past observations;
computing a correlation matrix for the plurality of predicted outcomes;
clustering the plurality of predicted outcomes in a plurality of clusters according to a plurality of clustering schemes based on the correlation matrix, each of the plurality of clustering schemes defines a different number of clusters;
selecting a clustering scheme which achieves a highest quality score among a plurality of quality scores computed for the plurality of clustering schemes;
computing, for each of the clusters of the selected clustering scheme, an aggregated predicted outcome which aggregates the predicted outcomes clustered in the respective cluster;
computing an estimated variance across the clusters of the selected clustering scheme; and
computing a false positive probability of a selected one of the plurality of statistical models based on the aggregated predicted outcome of the cluster comprising the predicted outcome computed by the selected statistical model, the number of clusters in the selected clustering scheme, and the estimated variance across all clusters in the selected clustering scheme.

2. The method of claim 1, wherein each of the plurality of predicted outcomes comprises a series of a plurality of partial predicted outcomes.

3. The method of claim 2, wherein the correlation matrix is computed for the plurality of predicted outcomes after aligning together the series of the plurality of predicted outcomes computed by the plurality of statistical models.

4. The method of claim 3, wherein the correlation matrix is computed based on pairwise alignment between each pair of the plurality of predicted outcomes by:
computing a respective one of a plurality of covariances between the series of the partial predicted outcomes of a first predicted outcome of a respective pair and the series of the partial predicted outcomes of a second predicted outcome of the respective pair,
computing a respective one of a plurality of variances for each of the plurality of predicted outcomes, and
computing the correlation matrix based on the plurality of covariances and the plurality of variances.

5. The method of claim 3, wherein the alignment is based on time alignment of the plurality of predicted outcomes by:
extracting a plurality of timestamps assigned to each of the plurality of partial predicted outcomes of each of the plurality of predicted outcomes,
forming a unified timestamp comprising a plurality of timestamp indexes which is a union of the plurality of extracted timestamps, and
re-indexing the plurality of partial predicted outcomes of each of the plurality of predicted outcomes according to the unified timestamp.

6. The method of claim 5, further comprising filling a zero value partial predicted outcome in each timestamp index missing a respective partial predicted outcome identified in the series of each of the plurality of predicted outcomes.

7. The method of claim 5, further comprising down-sampling the plurality of partial predicted outcomes of each of the plurality of predicted outcomes to match a median annual frequency of the series of the plurality of predicted outcomes.

8. The method of claim 1, further comprising repeating the clustering with a plurality of initialization settings.

9. The method of claim 1, wherein the plurality of statistical models correspond to a plurality of investment strategies trained based on backtesting of the plurality of past observations included in the historical dataset to compute predicted returns.

10. A system for estimating whether a statistical model selected from a plurality of statistical models trained using observed historical data is a false positive, comprising:
at least one processor executing a code, the code comprising:
code instructions to receive a plurality of predicted outcomes computed by a plurality of statistical models for a historical dataset comprising a plurality of past observations;
code instructions to compute a correlation matrix for the plurality of predicted outcomes;
code instructions to cluster the plurality of predicted outcomes in a plurality of clusters according to a plurality of clustering schemes based on the correlation matrix, each of the plurality of clustering schemes defines a different number of clusters;
code instructions to select a clustering scheme which achieves a highest quality score among a plurality of quality scores computed for the plurality of clustering schemes;
code instructions to compute, for each of the clusters of the selected clustering scheme, an aggregated predicted outcome which aggregates the predicted outcomes clustered in the respective cluster;
code instructions to compute an estimated variance across the clusters of the selected clustering scheme; and
code instructions to compute a false positive probability of a selected one of the plurality of statistical models based on the aggregated predicted outcome of the cluster comprising the predicted outcome computed by the selected statistical model, the number of clusters in the selected clustering scheme, and the estimated variance across all clusters in the selected clustering scheme.

11. A method of estimating whether a selected statistical model trained using observed historical data is a false positive, comprising:
using at least one processor for:
receiving a historical dataset comprising a plurality of past observations ordered along a past time flow;
partitioning the plurality of observations to a plurality of groups each comprising a respective subset of the plurality of past observations;
creating a plurality of combinatorial train-test sets each comprising the plurality of groups in a unique training-testing split in which at least some of the plurality of groups are included in a respective testing set and a reminder of the plurality of groups are included in a respective training set, the observations in the groups of each testing set are at least partially purged with respect to the observations in the groups of the respective training set;
receiving a plurality of predicted outcomes, each computed by applying an evaluated statistical model trained with the training set of a respective one the plurality of combinatorial train-test sets to the testing set of the respective combinatorial train-test set;
creating a plurality of virtual past time flows by aggregating the plurality of predicted outcomes; and
estimating whether the evaluated statistical model applied with at least one rule is a false based on a distribution of performance scores computed on the plurality of virtual past time flows.

12. The method of claim 11 wherein the purging is based on constructing the plurality of groups such that the respective subset of observations in the training set do not overlap in time with observations in the respective testing set.

13. The method of claim 12, further comprising enhancing the purging by inserting a predefined time margin between the respective subsets of observations of a group included in the training set and the subset of observations of a group included in the testing set such that observations identified in the predefined time margin are dropped from the training set.

14. The method of claim 11 wherein the training set in each of the plurality of combinatorial train-test sets is the union of all training data sets after purging.

15. The method of claim 11, wherein the evaluated statistical model corresponds to an investment strategy applied with at least one investment rule, the plurality of virtual past time flows are created based on backtesting of the time ordered observations included in the historical dataset.

16. A system estimating whether a selected statistical model trained using observed historical data is a false positive, comprising:
at least one processor executing a code, the code comprising:
code instructions to receive historical dataset comprising a plurality of past observations ordered along a past time flow;
code instructions to partition the plurality of observations to a plurality of groups each comprising a respective subset of the plurality of past observations;
code instructions to create a plurality of combinatorial train-test sets each comprising the plurality of groups in a unique training-testing split in which at least some of the plurality of groups are included in a respective testing set and a reminder of the plurality of groups are included in a respective training set, the observations in the groups of each testing set are at least partially purged with respect to the observations in the groups of the respective training set;
code instructions to receive a plurality of predicted outcomes each computed by applying an evaluated statistical model trained with the training set of a respective one the plurality of combinatorial train-test sets to the testing set of the respective combinatorial train-test set;
code instructions to construct a plurality of virtual past time flows by aggregating the plurality of predicted outcomes; and
code instructions to estimate whether the evaluated statistical model applied with at least one rule is a false based on a distribution of performance scores computed on the plurality of virtual past time flows.
